(19) United States
(12) Patent Application Publication
(10) Pub. No.: US 2018/0349815 A1
(43) Pub. Date: Dec. 6, 2018

(54) INFORMATION PROCESSING APPARATUS AND INFORMATION PROCESSING METHOD

(71) Applicant: FUJITSU LIMITED, Kawasaki-shi (JP)

(72) Inventors: Motoshi Sumioka, Kawasaki (JP); Masahide NODA, Kawasaki (JP); Junichi Yura, Kawasaki (JP); Tatsuro Matsumoto, Yokohama (JP)

(73) Assignee: FUJITSU LIMITED, Kawasaki-shi (JP)

(21) Appl. No.: 15/988,602

(22) Filed: May 24, 2018

(30) Foreign Application Priority Data
May 30, 2017 (JP) 2017-107126

(51) Int. Cl. G06Q 10/06

(52) U.S. Cl. CPC G06Q 10/0633; G06Q 10/067

(57) ABSTRACT

An information processing apparatus includes a processor configured to acquire basic flows each including basic tasks. The processor generates a complex flow having a multi-dimensional matrix structure by combining the basic flows with each other. The complex flow includes complex tasks corresponding to any of the basic tasks of the respective basic flows. The processor sets complex shift attributes for the respective complex tasks based on a basic shift attribute set for each of the basic tasks of at least one of the basic flows. Each of the complex shift attributes includes information on a shift between the complex tasks. The basic shift attribute includes information on a shift between the basic tasks. The processor performs a shift between the complex tasks starting from a head complex task of the complex tasks based on the complex shift attributes.

### CROSS-REFERENCE TO RELATED APPLICATION

This application is based upon and claims the benefit of priority of the prior Japanese Patent Application No. 2017-107126, filed on May 30, 2017, the entire contents of which are incorporated herein by reference.

### FIELD

The embodiments discussed herein are related to an information processing apparatus and an information processing method.

### BACKGROUND

A workflow is created to visualize a flow of a work in a business. By creating the workflow, for example, a plurality of workers involved in the work may share information such as a progress status or data of the work, and hence, the work may be smoothly progressed.

For example, in a system for managing an execution of a business project, the progress phases of the project may be divided into a plurality of processes on the time-series basis, such that the project is managed per process. In this case, in the system, the respective items of the processes divided on the time-series basis and the respective items of the processes divided on the basis of a thought process are stored in association with each other, such that the items are arranged and displayed in a form of a two-dimensional matrix. As a result, the execution of the project is smoothly progressed.

Related technologies are disclosed in, for example, Japanese Laid-Open Patent Publication Nos. 2014-052922 and 2004-192125.

### SUMMARY

According to an aspect of the present invention, provide is an information processing apparatus including a memory and a processor coupled to the memory. The processor is configured to acquire a plurality of basic flows each including a plurality of basic tasks. The processor is configured to generate a complex flow having a multi-dimensional matrix structure by combining the plurality of basic flows with each other. The complex flow includes a plurality of complex tasks corresponding to any of the basic tasks of the respective basic flows. The processor is configured to set complex shift attributes for the respective complex tasks based on a basic shift attribute set for each of the plurality of basic tasks of at least one of the plurality of basic flows. Each of the complex shift attributes includes information on a shift between the plurality of complex tasks. The basic shift attribute includes information on a shift between the plurality of basic tasks. The processor is configured to perform a shift between the plurality of complex tasks starting from a head complex task of the plurality of complex tasks based on the complex shift attributes. The head complex task corresponds to head basic tasks of the respective basic flows.

The object and advantages of the disclosure will be realized and attained by means of the elements and combinations particularly pointed out in the claims. It is to be understood that both the foregoing general description and the following detailed description are exemplary and explanatory and are not restirctive of the disclosure, as claimed.

### BRIEF DESCRIPTION OF DRAWINGS

FIG. 1 is a diagram for explaining an information processing system according to Embodiment 1;

FIG. 2 is a functional block diagram illustrating a functional configuration of a server device according to Embodiment 1;

FIG. 3 is a view illustrating an example of a screen configuration at the time of receiving a basic flow;

FIG. 4A is a diagram illustrating an example of a basic flow acquired by a basic flow acquisition unit;

FIG. 4B is a diagram illustrating an example of a basic flow acquired by the basic flow acquisition unit;

FIG. 5 is a view illustrating an example of basic flow information;

FIG. 6 is a view illustrating an example of basic task information;

FIG. 7 is a diagram illustrating an example of a complex flow;

FIG. 8 is a view illustrating an example of complex flow information;

FIG. 9 is a view illustrating an example of complex task information;

FIG. 10 is a view illustrating an example of customer information;

FIG. 11 is a view illustrating an example of flow instance information;

FIG. 12 is a diagram illustrating an example of a shift candidate extracted by a candidate extraction unit;

FIG. 13 is a diagram illustrating another example of the shift candidate extracted by the candidate extraction unit;

FIG. 14 is a diagram for explaining an unexecuted complex task;

FIG. 15 is a diagram illustrating another example of the shift candidate extracted by the candidate extraction unit;

FIG. 16 is a view illustrating an example of history information;

FIG. 17 is a view illustrating an example of unexecuted task information;

FIG. 18 is a view illustrating an example of task instance information;

FIGS. 19A and 19B are views illustrating an example of screen shift at the time of executing the complex flow;

FIG. 20 is a flowchart illustrating a procedure of a complex flow generating process according to Embodiment 1;

FIG. 21 is a flowchart illustrating a procedure of a complex flow executing process according to Embodiment 1;

FIG. 22 is a flowchart illustrating a procedure of a shift candidate extracting process according to Embodiment 1;

FIG. 23 is a flowchart illustrating a procedure of an unexecuted task extracting process according to Embodiment 1;

FIG. 24 is a view illustrating an example of a screen configuration at the time of generating the complex flow;

FIG. 25 is a view illustrating an example of a screen configuration for presenting a shift candidate;

FIG. 26 is a view for explaining an example of a setting of a complex shift attribute;

FIG. 27 is a diagram for explaining an example of shift according to a complex shift attribute;

FIG. 28 is a diagram for explaining an example of shift according to a complex shift attribute;

FIG. 29 is a view for explaining an example of a setting of a complex shift attribute; and

FIG. 30 is a diagram illustrating an example of a hardware configuration of a computer executing a complex flow program according to Embodiments 1 and 2.

### DESCRIPTION OF EMBODIMENTS

In the technology described above, it may be difficult to comprehensively manage a plurality of work flows.

The flow formed by multiple processes into which a project is divided in time-series basis is not necessarily generated only one in the corresponding project. That is, one or more flows each including multiple processes divided from a project in time-series basis may be generated in a corresponding project. For example, multiple flows which are different from each other in time for completing the entire processes may be created. In this case, the system stores, for each flow, the respective items of the processes divided in time-series basis and respective items of the processes divided on basis of thought process in association with each other, and hence, it is difficult to comprehensively manage the multiple work flows.

Hereinafter, embodiments of the information processing apparatus and the information processing method according to the present disclosure will be described with reference to the accompanying drawings. In addition, the present disclosure is not limited to the embodiments. In addition, the embodiments may be appropriately combined with each other within the scope that does not cause any inconsistency.

### Embodiment 1

[System Configuration]

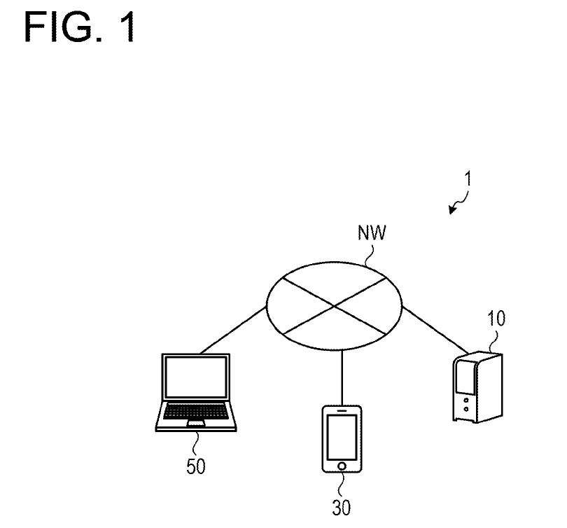

FIG. 1 is a view for explaining an information processing system according to Embodiment 1. An information processing system 1 illustrated in FIG. 1 supports a work of an insurance salesman by managing tasks performed by the insurance salesman when the insurance salesman performs an operation and sales of insurance.

As illustrated in FIG. 1, the information processing system 1 includes a server device 10, a user terminal 30, and an administrator terminal 50. While FIG. 1 represents one user terminal 30 and one administrator terminal 50, a plurality of user terminals 30 and a plurality of administrator terminals 50 may be provided for one server device 10.

The server device 10, the user terminal 30, and the administrator terminal 50 are connected to each other via a predetermined network NW. The network NW may be constructed by any type of a wired or wireless communication network such as the Internet, a local area network (LAN), or a virtual private network (VPN).

The server device 10 is an information processing device that implements the support of the work of the insurance salesman.

As for an embodiment, the server device 10 may be mounted as package software or on-line software by installing information processing programs for implementing various functions related to the work support in a desired computer. The various functions related to the work support include, for example, generating a workflow including tasks, storing an execution result of an executed task, and presenting an unexecuted task, as the management of the tasks. For example, the server device 10 may be mounted as a Web server for providing the function of the work support described above or a cloud system for providing the function of the work support by outsourcing.

The user terminal 30 may be used by an insurance salesman. In addition, the administrator terminal 50 may be used by an administrator who manages the tasks performed by the insurance salesman.

As for the user terminal 30 and the administrator terminal 50, mobile communication terminals such as smartphones or mobile phones, mobile terminal devices such as slate terminals or tablet terminals, and information processing devices such as desktop or laptop type personal computers, may be used.

[Configuration of Server Device 10]

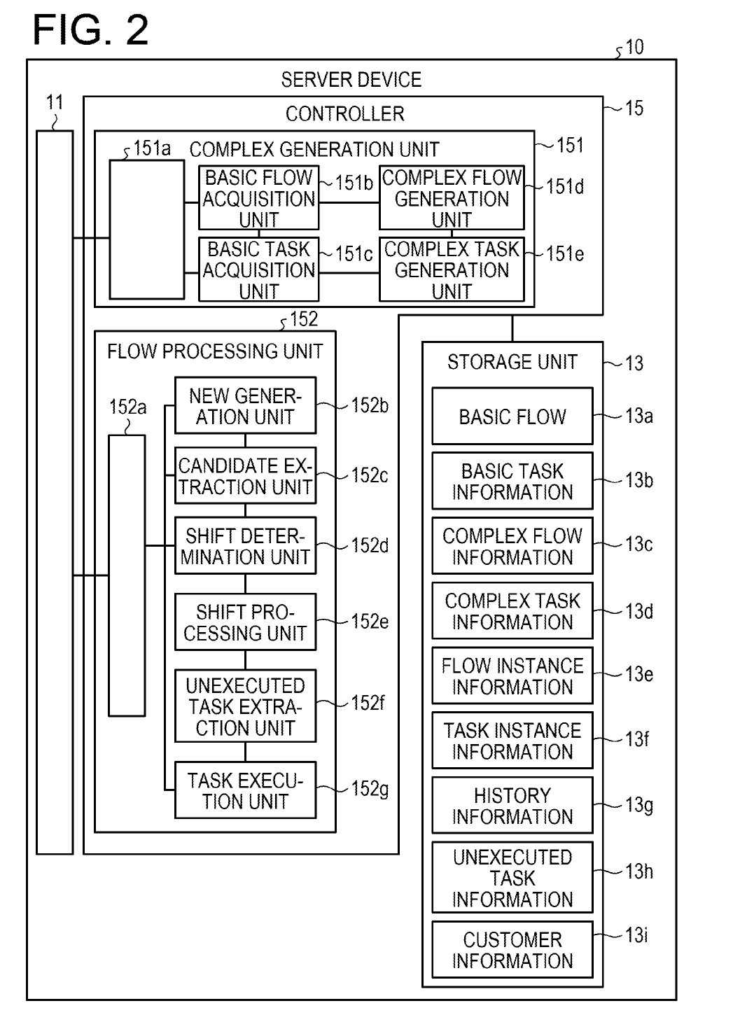

Next, the configuration of the server device 10 according to Embodiment 1 will be described. FIG. 2 is a functional block diagram illustrating a functional configuration of the server device 10 according to Embodiment 1. As illustrated in FIG. 2, the server device 10 includes a communication I/F 11, a storage unit 13, and a controller 15. Further, the server device 10 may include various functional units of a known computer such as an input unit and an output unit, in addition to the functional units illustrated in FIG. 1.

The communication I/F 11 is an interface that controls a communication with other devices such as the user terminal 30 and the administrator terminal 50. As an embodiment, a network interface card such as a LAN card may be adopted as the communication I/F 11.

The storage unit 13 is a storage device that stores data used not only for the operation system (OS) executed in the controller 15 but also for various programs such as an application program for implementing the function of the work support described above.

As an embodiment, the storage unit 13 may be mounted as an auxiliary storage device in the server device 10. For example, a hard disk drive (HDD), an optical disk, or a solid state drive (SSD) may be adopted as the storage unit 13. In addition, the storage unit 13 may not necessarily be mounted as an auxiliary storage device and may be mounted as a main storage device in the server device 10. In this case, various semiconductor memory elements such as a RAM or a flash memory may be adopted as the storage unit 13.

The storage unit 13 stores basic flow information 13a, basic task information 13b, complex flow information 13c, and complex task information 13d, as an example of data used for the programs executed by the controller 15. Further, the storage unit 13 stores flow instance information 13e, task instance information 13f, history information 13g, unexecuted task information 13h, and customer information 13i. In addition to the data, the storage unit 13 may store the following electronic data. For example, the storage unit 13 may further store account information of the insurance salesman or the administrator, customer information, and information such as identification information for identifying the user terminal 30 or the administrator terminal 50. Each piece of information stored in the storage unit 13 will be described later in accordance with the descriptions of the controller 15 that acquires or generates the information.

The controller 15 is a processing unit that controls the entire server device 10.

As an embodiment, the controller 15 may be mounted by a hardware processor such as a CPU or an MPU. Here, while an example of the processor is the CPU or MPU, the controller 15 may be mounted by any general-purpose or specialized processor. In addition, the controller 15 may be implemented by a hard wired logic such as an ASIC or FPGA.

The controller 15 virtually implements the processing units described below by developing a complex flow program on a work area of a RAM such as a DRAM or SRAM which is mounted as a main storage device (not illustrated).

As illustrated in FIG. 2, the controller 15 includes a complex generation unit 151 and a flow processing unit 152.

The complex generation unit 151 is a processing unit that generates a management flow for the work support based on information acquired from the administrator terminal 50.

The complex generation unit 151 includes an administrator display controller 151a, a basic flow acquisition unit 151b, a basic task acquisition unit 151c, a complex flow generation unit 151d, and a complex task generation unit 151e.

As an embodiment, the administrator display controller 151a is a processing unit that controls the display of various pieces of information on a display unit (not illustrated) of the administrator terminal 50.

For example, upon receiving an access from the administrator terminal 50, the administrator display controller 151a transmits information of various operation screens to the administrator terminal 50 of the access source, and controls the operation screens to be displayed on the administrator terminal 50 of the access source. For example, according to the access from the administrator terminal 50, the administrator display controller 151a causes the administrator terminal 50 to display a login screen, so as to receive input of an administrator ID and the login. When the login is successful, the administrator display controller 151a controls various screens such as the operation screens to be displayed on the administrator terminal 50. For example, the administrator display controller 151a causes a screen for newly receiving a plurality of basic flows to be displayed on the administrator terminal 50.

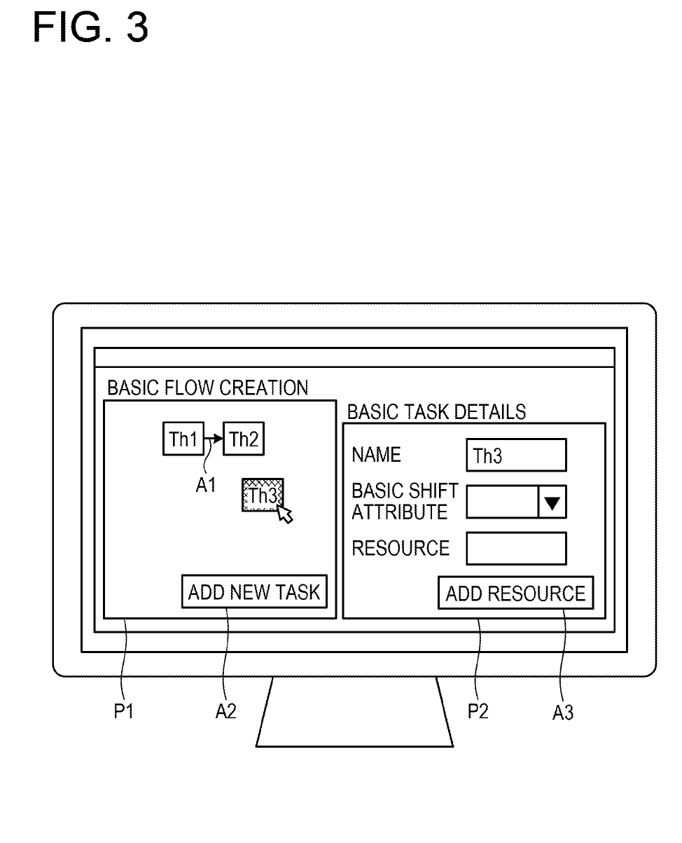

FIG. 3 is a view illustrating an example of a screen configuration at the time of receiving a basic flow. FIG. 3 illustrates an example of a screen displayed on the administrator terminal 50 at the time of receiving a basic flow. The screen includes a flow screen area P1 that displays a basic flow, and a task screen area P2 that displays details of a task included in the basic flow.

The flow screen area P1 displays tasks Th1 to Th3 included in the basic flow and an arrow Al indicating a flow between tasks. Further, in the flow screen area P1, a new task addition icon A2 for adding a new task is provided. For example, when the administrator operates the new task addition icon A2, a new task may be added to the flow screen area P1.

The task screen area P2 displays detailed information of the task Th3 (basic task details) selected in the flow screen area P1. The detailed information of the task Th3 includes, for example, a name and a basic shift (transition) attribute of the task Th3 and a resource to be called at the time of executing the task Th3. Here, the basic shift attribute is information on shift between the task Th3 and a next task. The basic shift attribute includes, for example, a skippable attribute for permitting shift to the next task without performing the task Th3 and an unskippable attribute for permitting the shift to the next task on a condition that the task Th3 be executed. Further, the basic shift attribute includes a post-executable attribute for permitting the shift to the next task on a condition that the task Th3 be executed before the basic flow is ended, that is, permitting returning to and executing the task Th3 after the shift to the next task. In addition, the unskippable attribute has the shift condition requiring that the task be performed. Thus, unlike the task in which the post-executable attribute is set, the task in which the unskippable attribute is set may not be retroactively executed after the shift to the next task, and thus, is not permitted to be executed afterward. In addition, the basic shift attribute is selected from, for example, a pull-down menu.

The resource to be called at the time of executing the task Th3 includes, for example, a file in which customer information is written, a file of, for example, an insurance advertisement, or an application such as a customer registration application or a map application. In the task screen area P2, a resource addition icon A3 for adding a resource is provided. For example, when the administrator operates the resource addition icon A3, a list of resources that may be added is displayed on the screen, and when the administrator selects a resource from the list, the selected resource is added to the task Th3.

Referring back to the descriptions of FIG. 2, the basic flow acquisition unit 151b is a processing unit that acquires a plurality of basic flows each including a plurality of basic tasks from the administrator terminal 50.

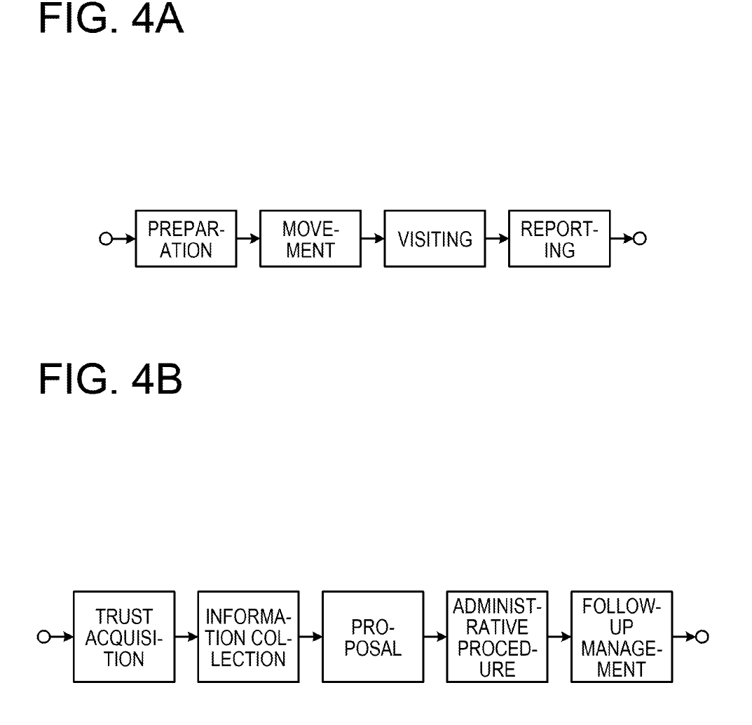

The basic flow acquisition unit 151b acquires a flow input and received in the flow screen area P1 (see FIG. 3), as a basic flow. Hereinafter, a specific example of the basic flow will be described with reference to FIGS. 4A and 4B. FIGS. 4A and 4B are diagrams illustrating an example of a basic flow acquired by the basic flow acquisition unit 151b. For example, as illustrated in FIG. 4A, the basic flow acquisition unit 151b acquires a basic flow related to a case where the insurance salesman visits a customer. This basic flow includes tasks including “preparation” for the visit to the customer and “movement” at the time of the visit, a “visiting” task, and a “reporting” task after the visit. The basic flow illustrated in FIG. 4A is, for example, a workflow (visiting flow) related to tasks (works) executed by the insurance salesman in a short time period (e.g., several days). Hereinafter, the basic flow illustrated in FIG. 4A will be referred to as a short-term flow.

In addition, as illustrated in FIG. 4B as an example, the basic flow acquisition unit 151b acquires a basic flow related to a case where an insurance salesman makes an insurance contract with the customer. This basic flow includes tasks such as “trust acquisition” from the customer or customer “information collection,” “proposal” of insurance, “administrative procedure” of a contract, and “follow-up management” after the contract. The basic flow illustrated in FIG. 4B is, for example, a workflow (customer acquisition flow) related to tasks executed by the insurance salesman to acquire customers over a long time period (e.g., several months or years). Hereinafter, the basic flow illustrated in FIG. 4B will be referred to as a long-term flow. In addition, it is assumed that the administrator designates whether each of the plurality of basic flows acquired from the administrator terminal 50 is the short-term flow or long-term flow, via the administrator terminal 50.

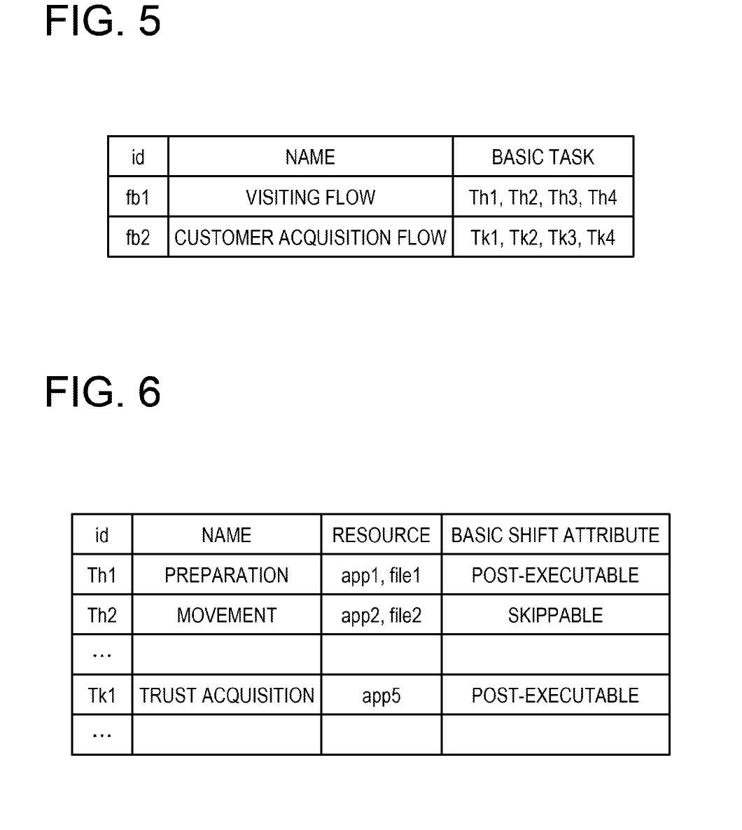

The basic flow acquisition unit 151b stores the acquired short-term flow and long-term flow as basic flow information 13a in the storage unit 13. Hereinafter, a specific example of the basic flow information 13a will be described with reference to FIG. 5. FIG. 5 is a view illustrating an example of the basic flow information 13a. As illustrated in FIG. 5, the basic flow acquisition unit 151b stores data in which an “id” (identification) for identifying a basic flow, a name of the basic flow, and “ids” of a plurality of basic tasks included in the basic flow are associated with each other, as the basic flow information 13a in the storage unit 13. In addition, the “id” of each basic task is an “id” for identifying the basic task included in the basic flow, and may be an “id” for identifying a basic task acquired by the basic task acquisition unit 151c to be described later. In addition, in the example of FIG. 5, the basic flow acquisition unit 151b stores the basic flow information 13a in which the name of the short-term flow is the “visiting flow” and the name of the long-term flow is the “customer acquisition flow,” in the storage unit 13.

Referring back to the descriptions of FIG. 2, the basic task acquisition unit 151c is a processing unit that acquires information on the plurality of basic tasks included in each of the short-term flow and the long-term flow, from the administrator terminal 50.

The basic task acquisition unit 151c acquires information input and received in the task screen area P2 (see FIG. 3), as information on the basic tasks. The basic task acquisition unit 151c stores the acquired information as basic task information 13b in the storage unit 13.

FIG. 6 is a view illustrating an example of the basic task information 13b. As illustrated in FIG. 6, the basic task acquisition unit 151c stores data in which an “id” for identifying a basic task, a name of the basic task, a resource to be called at the time of executing the basic task, and a basic shift attribute of the basic task are associated with each other, as the basic task information 13b. In the example of FIG. 6, the basic task information 13b stores, for example, an application such as “app1” and a file such as “file1” as resources of the basic task Th1, and “post executable” as the basic shift attribute, in the storage unit 13. Further, the basic task information 13b stores “app2” and “filet” as resources of the basic task Th2 and “skippable” as the basic shift attribute, in the storage unit 13.

Referring back to the descriptions of FIG. 2, the complex flow generation unit 151d is a processing unit that generates a complex flow.

The complex flow generation unit 151d combines the plurality of basic flows acquired by the basic flow acquisition unit 151b with each other, so as to generate a complex flow having a multi-dimensional matrix structure and including a plurality of complex tasks corresponding to the plurality of respective basic tasks of each basic flow.

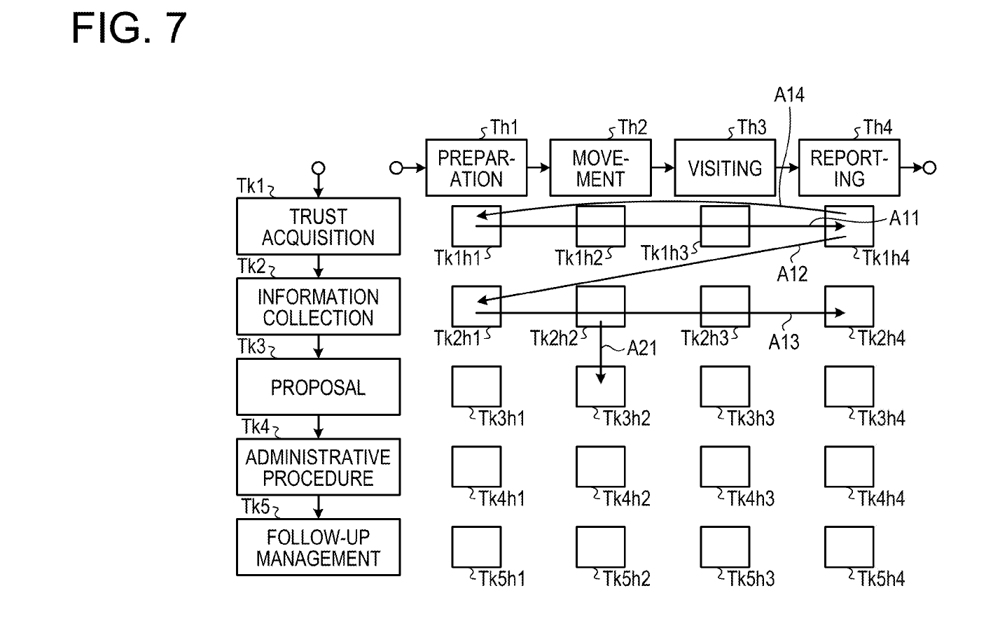

Descriptions will be made on an example of the complex flow generated by the complex flow generation unit 151d with reference to FIG. 7. FIG. 7 is a diagram illustrating an example of the complex flow. Here, for example, it is assumed that the basic flow acquisition unit 151b acquires the short-term flow including tasks Th1 to Th4 and the long-term flow including tasks Tk1 to Tk5. In this case, the complex flow generation unit 151d generates, for example, a complex flow having a 4×5 two-dimensional matrix structure in which the horizontal axis indicates the short-term flow and the vertical axis indicates the long-term flow. Further, the complex flow generation unit 151d generates 4×5 tasks Tk1h1 to Tk5h4 included in the complex flow. Hereinafter, the tasks of the basic flows will be referred to as basic tasks, and the tasks of the complex flow will be referred to as complex tasks. Each of the complex tasks Tk1h1 to Tk5h4 corresponds to one of the plurality of basic tasks Th1 to Th4 included in the short-term flow, and one of the plurality of basic tasks Tk1 to Tk5 included in the long-term flow. For example, as illustrated in FIG. 7, the complex task Tk2h2 corresponds to the basic task Th2 of the short-term flow and the basic task Tk2 of the long-term flow.

Here, the shift between the complex tasks of the complex flow will be described. The shift between the complex tasks Tk1h1 to Tk5h4 is basically performed on each single line one after another along the complex flow of the matrix structure. That is, in the complex flow of FIG. 7, the shift is performed from the complex task Tk1l1 at the left upper side in an order of the complex tasks Tk1h2, Tk1h3, and Tk1h4. After the complex task Tk1h4, the shift is performed in an order of the complex tasks Tk2h1 to Tk2h4 which correspond to the next basic task Tk2 of the long-term flow.

Specifically, in the example illustrated in FIG. 7, for example, the shift is performed in an order of the complex tasks Tk1h1, Tk1h2, Tk1h3, and Tk1h4 along the short-term flow, as indicated by an arrow All. When the shift along the short-term flow is ended, that is, when the shift along the arrow All reaching the complex task Tk1h4 is ended, the shift is performed along the long-term flow, and then, returns to the head of the short-term flow such that the shift between the complex tasks is performed. That is, the shift is performed from the complex task Th4k1 to the complex task Tk2h1 as indicated by an arrow A12, and performed along the short-term flow as indicated by an arrow A13. In addition, for example, as indicated by an arrow A14, the shift may return to the head complex task Tk1h1 of the short-term flow without the performance of the shift along the long-term flow.

In addition, in the complex flow, the shift along the long-term flow may be performed, regardless of whether the shift along the short-term flow is ended. For example, as indicated by an arrow A21 in FIG. 7, the shift may be performed from the complex task Tk2h2 to the complex task Tk3h2 even when the shift along the short-term flow is being performed. In addition, the shift between the complex tasks is executed by a shift processing unit 152e to be described later.

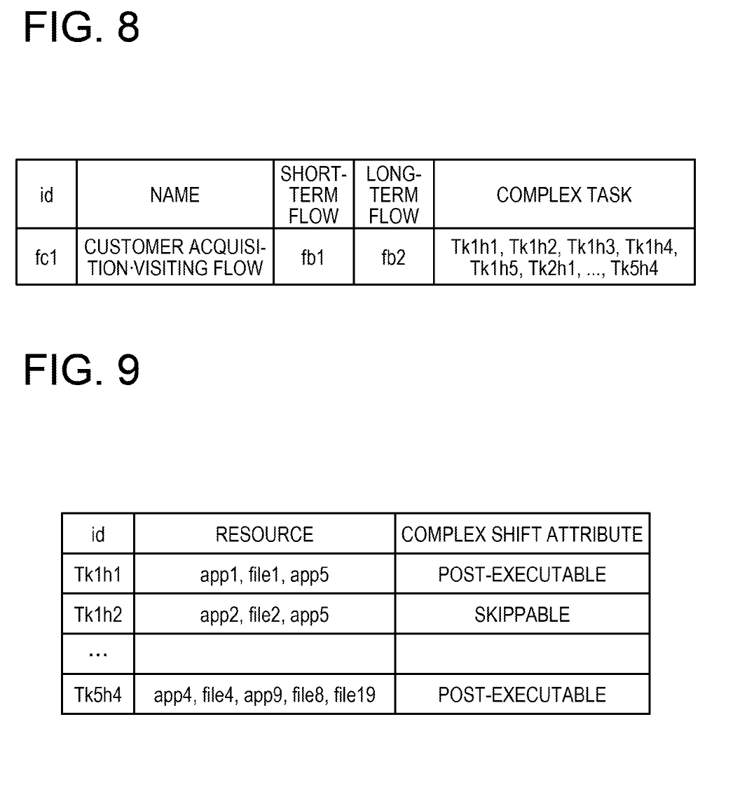

The complex flow generation unit 151d stores the generated complex flow as complex flow information 13c in the storage unit 13. FIG. 8 is a view illustrating an example of the complex flow information 13c. As illustrated in FIG. 8, the complex flow generation unit 151d stores data in which an “id” for identifying the complex flow, a name of the complex flow, an “id” for identifying the short-term flow, an “id” for identifying the long-term flow, and an “id” for identifying each of the plurality of complex tasks included in the complex flow are associated with each other, as the complex flow information 13c in the storage unit 13. In the example of FIG. 8, the complex flow generation unit 151d stores the complex flow information 13c in which the name of the complex flow is “customer acquisition/visiting flow,” in the storage unit 13.

Referring back to the descriptions of FIG. 2, the complex task generation unit 151e is a processing unit that generates information on the plurality of complex tasks Tk1h1 to Tk5h4 based on the plurality of basic tasks Th1 to Tk5 acquired by the basic task acquisition unit 151c.

The complex task generation unit 151e stores the generated information on the plurality of complex tasks Tk1h1 to Tk5h4 as complex task information 13d in the storage unit 13. An example of the complex task information 13d will be described with reference to FIG. 9. FIG. 9 is a view illustrating an example of the complex task information 13d. The complex task information 13d is data in which an “id,” a resource, and a complex shift attribute of each complex task are associated with each other.

As an embodiment, the complex task generation unit 151e corresponds to a setting unit that sets complex shift attributes of the complex tasks Tk1h1 to Tk5h4 based on the basic shift attributes of the basic tasks Th1 to Tk5. In addition, the complex shift attribute is information on the shift between the complex tasks Tk1h1 and Tk5h4. Similar to the basic shift attribute, the complex shift attribute includes the skippable attribute, the unskippable attribute, and post-executable attribute.

As illustrated in FIG. 9, the complex task generation unit 151e sets the basic shift attribute (“post-executable” in the example of FIG. 6) set for the basic task Th1 of the short-term flow corresponding to the complex task Tk1h1, as the complex shift attribute of the complex task Tk1h1.

Further, the complex task generation unit 151e sets resources to be called at the time of executing the complex tasks Tk1h1 to Tk5h4. Specifically, the complex task generation unit 151e sets the resources set for the basic tasks Th1 to Tk5 corresponding to the complex tasks Tk1h1 to Tk5h4, as the resources of the complex tasks Tk1h1 to Tk5h4. For example, as illustrated in FIG. 9, the complex task generation unit 151e sets the resources “app1” and “file1” of the basic task Th1 corresponding to the complex task Tk1h1, as resources of the complex task Tk1h1. Further, the complex task generation unit 151e sets a resource “app5” of the basic task Tk1 corresponding to the complex task Tk1h1, as a resource of the complex task Tk1h1.

Referring back to the descriptions of FIG. 2, the flow processing unit 152 is a processing unit that executes the complex tasks Tk1h1 to Tk5h4 along the complex flow generated by the complex generation unit 151.

The flow processing unit 152 includes a user display controller 152a, a new registration unit 152b, a candidate extraction unit 152c, a shift determination unit 152d, a shift processing unit 152e, an unexecuted task extraction unit 152f, and a task execution unit 152g.

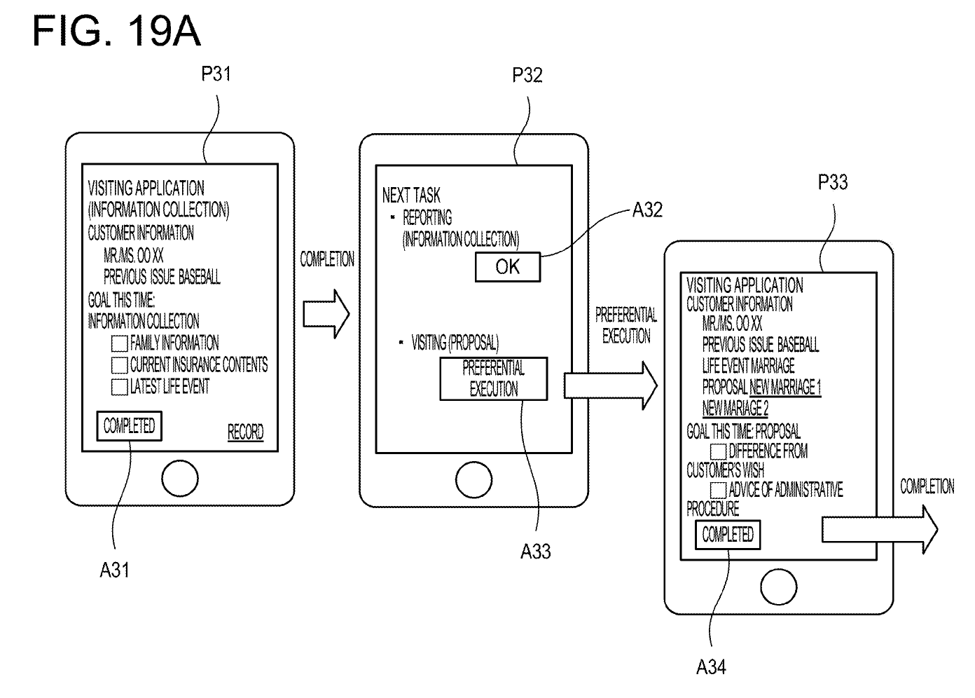

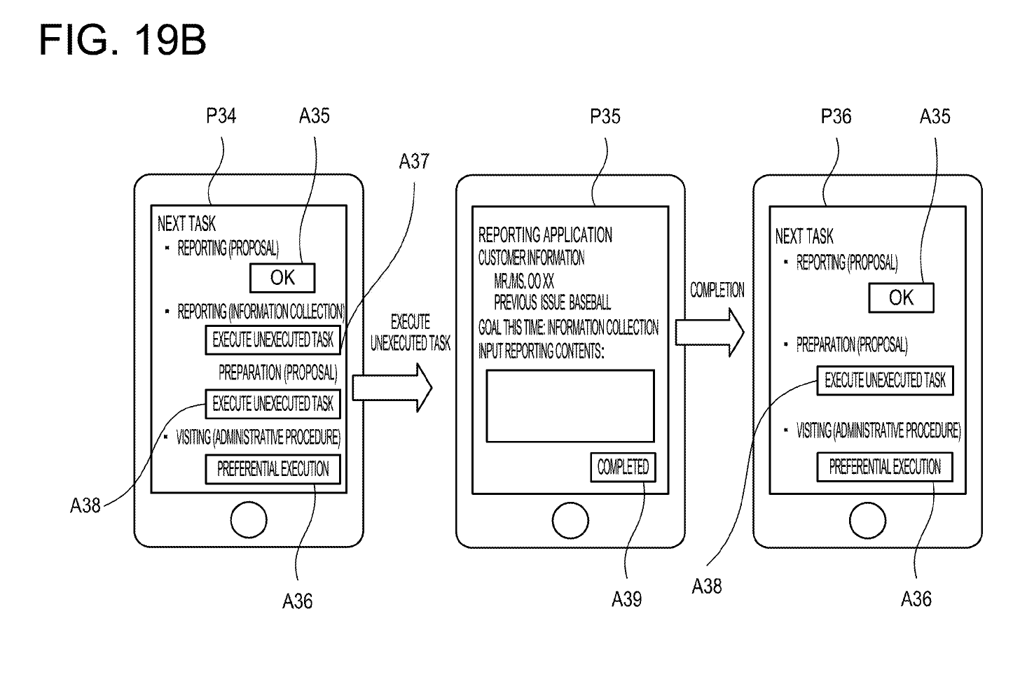

As an embodiment, the user display controller 152a controls the display of various pieces of information on a display unit (not illustrated) of the user terminal 30. For example, upon receiving an access from the user terminal 30, the user display controller 152a transmits information of various operation screens to the user terminal 30 of the access source, and controls the operation screens to be displayed on the user terminal 30 of the access source. For example, according to the access from the user terminal 30, the user display controller 152a causes the user terminal 30 to display a login screen, so as to receive input of a user ID and the login. When the login is successful, the user display controller 152a controls various screens such as operation screens to be displayed on the user terminal 30. For example, the user display controller 152a causes the user terminal 30 to display a screen for receiving a registration of a new customer, or a screen for performing shift between the complex tasks of the complex flow corresponding to a registered customer or executing the complex tasks. In addition, the various screens caused by the user display controller 152a to be displayed on the user terminal 30 will be described later with reference to FIGS. 19A and 19B.

Next, the new registration unit 152b is a processing unit that registers a new customer upon receiving a request for the registration of the new customer from the user terminal 30.

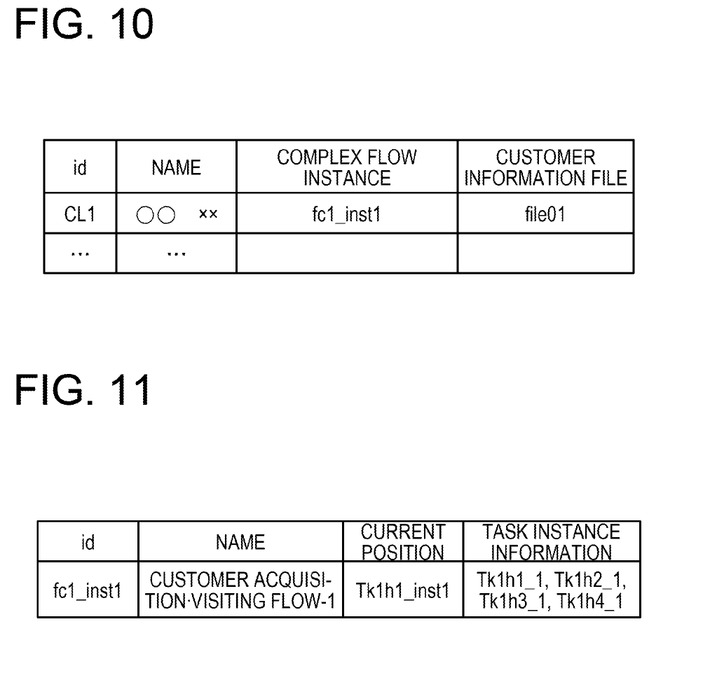

Upon receiving the request for the registration of the new customer from the user terminal 30, the new registration unit 152b generates customer information 13i and stores the customer information 13i in the storage unit 13. FIG. 10 is a view illustrating an example of the customer information 13i. As illustrated in FIG. 10, the new registration unit 152b stores data in which an “id,” a name, a complex flow instance, and a customer information file of the customer are associated with each other, as the customer information 13i in the storage unit 13. Here, the customer information file corresponds to, for example, the “file 1” that is called in the basic task Th1, and is a data file for storing information such as a name, address, age, and family members of the customer.

In addition, the complex flow instance is an instance of the complex flow corresponding to each customer “id.” In this way, the complex flow is executed for each customer. The new registration unit 152b generates flow instance information 13e including the information on the complex flow instance, and sets a complex flow instance “id” included in the generated flow instance information 13e as a complex flow instance of the customer information 13i.

Here, the flow instance information 13e will be described with reference to FIG. 11. FIG. 11 is a view illustrating an example of the flow instance information 13e. As illustrated in FIG. 11, the flow instance information 13e is data in which an “id” and a name of the complex flow instance, a current position of the complex tasks, and task instance information of the complex flow are associated with each other. The task instance information of the complex flow is information of an instance of at least one of the plurality of complex tasks included in the complex flow. Specifically, in the example of FIG. 11, instances of the complex tasks Tk1h1 to Tk1h4 corresponding to one basic task Tk1 of the long-term flow and the basic tasks Th1 to Th4 of the short-term flow are included as task instance information in the flow instance information 13e. Here, in order to distinguish the task instances from the complex tasks Tk1h1 to Tk5h4, each of the task instances is given a code having a subscript such as “_1.” For example, in FIG. 11, the task instances of the complex tasks Tk1h1 to Tk1h4 are described as task instances Tk1h1_1 to Tk1h4_1.

In addition, the current position of the flow instance information 13e illustrated in FIG. 11 is information indicating a task instance of a complex task which is being executed at the current time, among the complex tasks Tk1h1 to Tk5h4 of the complex flow executed for each customer. Since the complex tasks Tk1h1 to Tk5h4 are not yet executed at the time when the new registration unit 152b generates the flow instance information 13e, the current position is blank or is information indicating that the complex flow is not yet executed (“Tk1h1_inst1” in FIG. 11). In addition, the current position of the flow instance information 13e is updated at a timing when the shift between the complex tasks Tk1h1 and Tk5h4 is performed by the shift processing unit 152e to be described later, and an instance of a complex task after the shift is stored as the current position.

Further, the task instance information of the flow instance information 13e is updated in a case where the shift along the long-term flow, that is, the shift in the vertical direction in FIG. 7 is performed by the shift processing unit 152e. For example, in a case where the shift between the complex tasks is performed in the vertical direction as indicated by the arrow A12 or A21 illustrated in FIG. 7, task instances Tk2h1_1 to Tk2h4_1 are added as the task instance information. In addition, the task instance information may be updated even when the shift does not include the shift in the vertical direction. For example, in a case where the shift is performed from the complex task Tk1h4 corresponding to the end of the short-term flow to the complex task Tk1h1 corresponding to the head of the short-term flow as indicated by the arrow A14 in FIG. 7, task instances Tk1h1_2 to Tk1h4_2 are added.

Referring back to the descriptions of FIG. 2, the candidate extraction unit 152c is a processing unit that extracts a candidate for a complex task which is a next shift destination, according to the current position of the task instance information 13f and the complex shift attribute of the complex task information 13d.

For example, when the new registration unit 152b registers a new customer, the complex flow corresponding to the customer has not been executed. Thus, the candidate extraction unit 152c extracts the first complex task of the complex flow, that is, the complex task Tk1h1 corresponding to the first basic tasks Th1 and Tk1 included in the short-term flow and the long-term flow, respectively, as the shift candidate.

In addition, for example, when the shift processing unit 152e to be described later has already performed the shift between the complex tasks of the complex flow, the candidate extraction unit 152c extracts the shift candidate according to the current position or the complex shift attribute of a corresponding complex task.

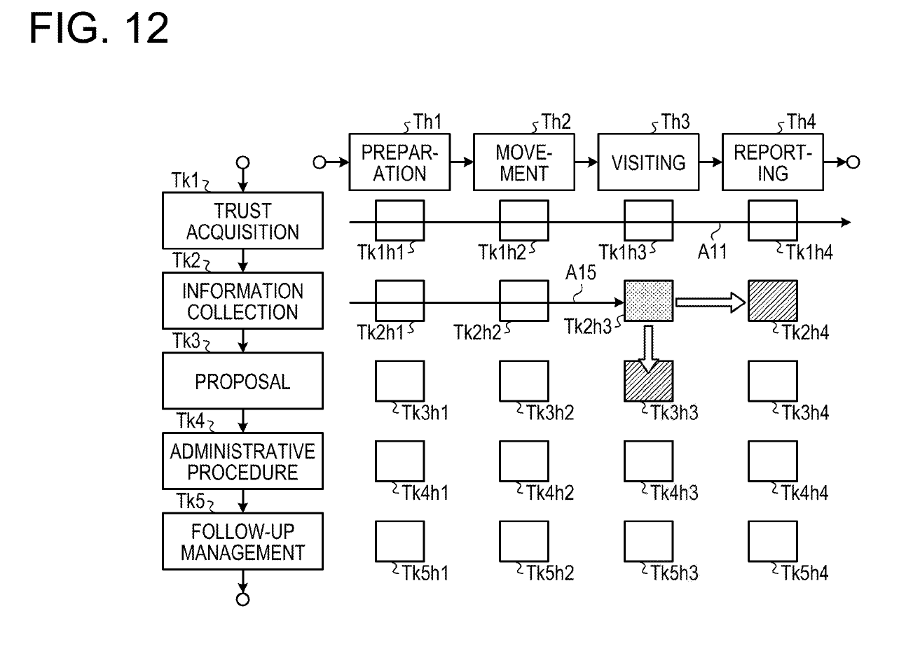

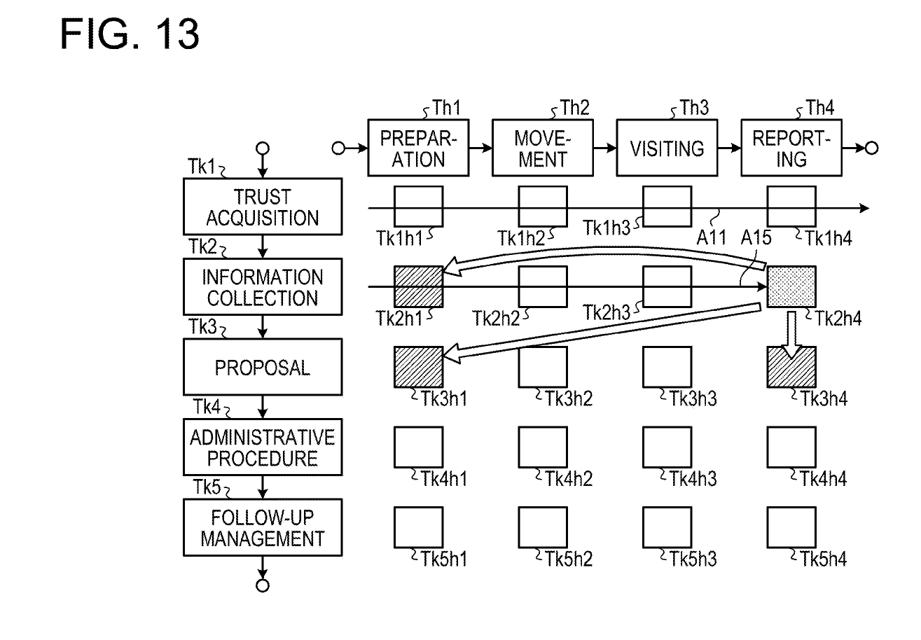

FIG. 12 is a diagram illustrating an example of the shift candidate extracted by the candidate extraction unit 152c. For example, it is assumed that the shift between the complex tasks Tk1h1 and Tk2h3 is being performed as indicated by arrows A11 and A15 in FIG. 12, and the current position of the task instance information 13f is the complex task Tk2h3. In this case, the candidate extraction unit 152c extracts the complex task Tk2h4 as the shift candidate in a case where the shift is performed along the short-term flow. Further, the candidate extraction unit 152c extracts the complex task Tk3h3 as the shift candidate in a case where the shift is performed along the long-term flow.

For example, in a case where the shift is performed from the complex task Tk2h3 at the current position along the long-term flow, that is, in a case where the shift is performed from the complex task Tk2h3 to the complex task Tk3h3, the complex tasks Tk2h4 to Tk3h2 are skipped and are not executed. At this time, when the unskippable attribute is set in the complex tasks Tk2h4 to Tk3h2, the shift is opposite to the complex shift attribute set in the complex tasks Tk2h4 to Tk3h2. In this case, the candidate extraction unit 152c does not extract the complex task Tk3h3 as the shift candidate. As described above, when the shift is performed along the long-term flow, it is assumed that the unskippable attribute is set in at least one of the complex tasks Tk2h4 to Tk3h2 along the short-term flow between the complex task Tk2h3 before the shift and the complex task Tk3h3 after the shift. In this case, the candidate extraction unit 152c extracts the complex task Tk2h4 which is the shift destination along the short-term flow, as the shift candidate, instead of extracting the complex task Tk3h3 which is the shift destination along the long-term flow.

FIG. 13 is a diagram illustrating another example of the shift candidate extracted by the candidate extraction unit 152c. In the example of FIG. 13, it is assumed that the current position of the task instance information 13f is the complex task Tk2h4. In this case, the candidate extraction unit 152c extracts the complex task Tk3h4 as the shift candidate in a case where the shift is performed along the long-term flow.

In addition, the candidate extraction unit 152c determines whether the short-term flow corresponding to the basic task Tk2 of the long-term flow has been ended, and extracts the shift candidate according to the determination result. For example, in the case of FIG. 13, the candidate extraction unit 152c determines whether the information collection corresponding to the basic task Tk2 of the long-term flow has been sufficiently performed. For example, the candidate extraction unit 152c determines that the information collection has been sufficiently performed, when all necessary items of the customer information file are filled in. In this case, the candidate extraction unit 152c extracts the complex task Tk3h1 which is the destination of the shift performed along the long-term flow, and simultaneously, returning to the head of the short-term flow, as the shift candidate.

Meanwhile, for example, when the necessary items of the customer information file include any blank field, the candidate extraction unit 152c determines that the information collection is insufficient. In this case, the candidate extraction unit 152c extracts the complex task Tk2h1 which is the destination of the shift returning to the head of the short-term flow without performing the shift along the long-term flow, as the shift candidate. Thus, the shift along the long-term flow may be performed when the basic tasks Tk1 to Tk5 of the long-term flow are more reliably executed. In addition, here, while the candidate extraction unit 152c determines whether or not to perform the shift along the long-term flow, the present disclosure is not limited thereto. For example, the user may select whether or not to perform the shift along the long-term flow. In this case, the candidate extraction unit 152c extracts both the complex tasks Tk2h1 and Tk3h1 as the shift candidates.

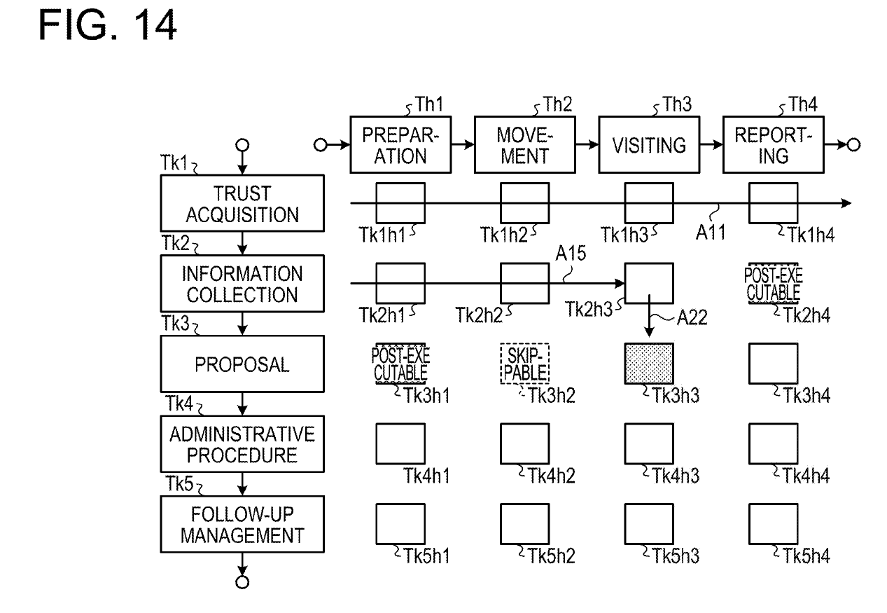

Next, descriptions will be made on the shift candidate extracted by the candidate extraction unit 152c in a case where an executed complex task exists. Here, first, the unexecuted complex task will be described with reference to FIG. 14. FIG. 14 is a diagram for explaining the unexecuted complex task. For example, as illustrated in FIG. 14, it is assumed that the shift between the complex tasks Tk1h1 and Tk2h3 is performed along arrows A11 and A15, and then, the shift along the long-term flow is performed as indicated by an arrow A22. In this case, the complex tasks Tk2h4, Tk3h1, and Tk3h2 are not executed, and the current position of the complex tasks is updated from the complex task Tk2h3 to the complex task Tk3h3. Among the unexecuted complex tasks Tk2h4, Tk3h1, and Tk3h2, the complex task Tk3h2 has the skippable attribute for permitting the shift to the next task Tk3h3 without executing the complex task Tk3h2. Meanwhile, the complex tasks Tk2h4 and Tk3h1 have the post-executable attribute for permitting returning to and executing the complex tasks Tk2h4 and Tk3h1 after the shift to the next complex task Tk3h3. In this case, the complex tasks Tk2h4 and Tk3h1 correspond to unexecuted tasks that have to be executed before the end of the complex flow but are not yet executed at the present time.

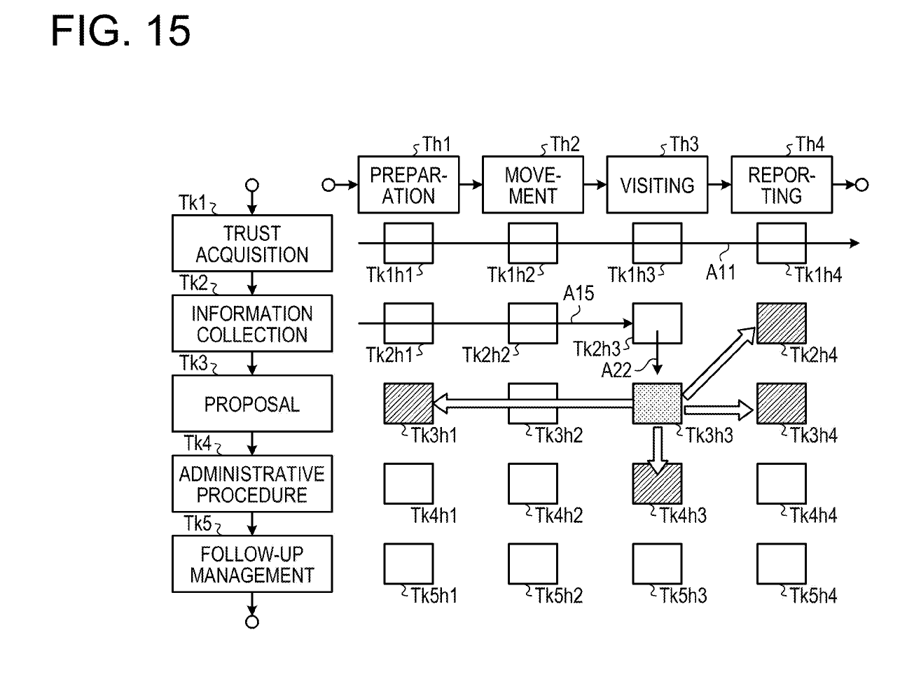

Subsequently, FIG. 15 is a diagram illustrating another example of the shift candidate extracted by the candidate extraction unit 152c. As described above, when the shift is performed from the complex task Tk2h3 to the complex task Tk3h3, the complex tasks Tk2h4 and Tk3h1 correspond to unexecuted tasks. In this case, the candidate extraction unit 152c extracts the complex task Tk3h4 which is the shift destination in a case where the shift is performed along the short-term flow, and the complex task Tk4h3 which is the shift destination in a case where the shift is performed along the long-term flow, as the shift candidates. Further, the candidate extraction unit 152c extracts the complex tasks Tk2h4 and Tk3h1 which are the unexecuted tasks, as the shift candidates.

Referring back to the descriptions of FIG. 2, the candidate extraction unit 152c displays the extracted shift candidates on the user terminal 30 via the user display controller 152a. In addition, an example of the display of the shift candidates by the user display controller 152a will be described later with reference to FIGS. 19A and 19B.

The shift determination unit 152d is a processing unit that determines the next shift destination from the shift candidates extracted by the candidate extraction unit 152c.

The shift determination unit 152d determines a shift candidate selected by the user via the user terminal 30 as the next shift destination, and outputs the determined shift destination to the shift processing unit 152e.

In addition, when the user terminal 30 selects shift to an unexecuted task, the shift determination unit 152d determines the complex task before the shift to the unexecuted task, as the shift destination after the shift to the unexecuted task. For example, as illustrated in FIG. 15, it is assumed that the current position of the complex tasks is the complex task Tk3h3, and the shift candidates are the unexecuted tasks Tk2h4 and Tk3h1, and the complex tasks Tk3h4 and Tk4h3. In this case, when the user terminal 30 selects shift to the unexecuted task Tk2h4, the shift determination unit 152d determines the unexecuted task Tk2h4 as the next shift destination of the complex task Tk3h3. Further, the shift determination unit 152d determines the complex task Tk3h3 as the shift destination after the execution of the unexecuted task Tk2h4. In this way, the shift determination unit 152d determines the shift destination such that the shift to the unexecuted task Tk2h4 is performed, and then, the shift returns to the complex task Tk3h3 before the shift, after the unexecuted task Tk2h4 is executed. As a result, the server device 10 may execute the complex tasks along the complex flow while executing the unexecuted task Tk2h4.

Referring back to the descriptions of FIG. 2, the shift processing unit 152e is a processing unit that performs the shift between the complex tasks.

The shift processing unit 152e changes the current position of the complex tasks to the shift destination determined by the shift determination unit 152d. Specifically, the shift processing unit 152e updates the current position of the flow instance information 13e to the instance of the complex task of the shift destination.

Further, the shift processing unit 152e updates the history information 13g. Here, the history information 13g is information generated by the shift processing unit 152e when the complex flow corresponding to a customer is executed. The history information 13g is generated by the shift processing unit 152e when the shift to the complex task Tk1h1 which is the first task of the complex flow is performed, and stored in the storage unit 13. The history information 13g is updated by the shift processing unit 152e each time the shift between the complex tasks is performed.

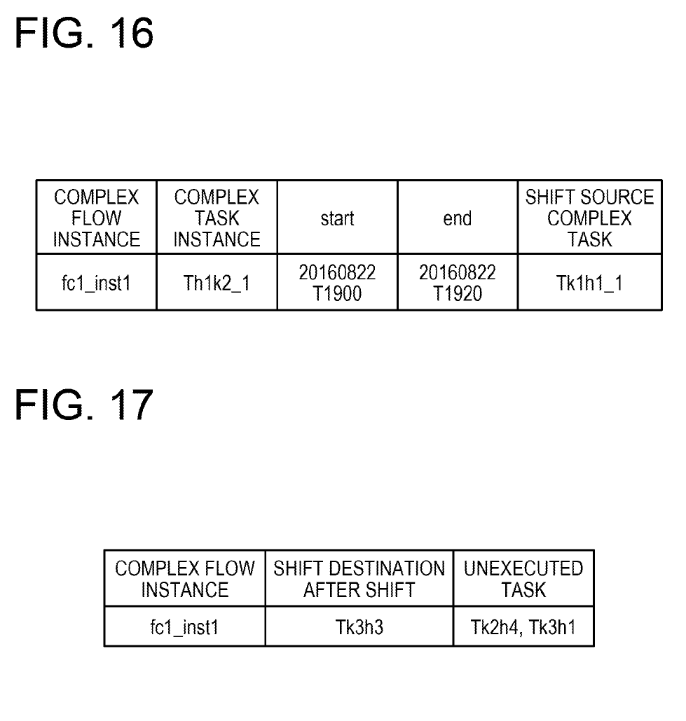

FIG. 16 is a view illustrating an example of the history information 13g. The history information 13g is data in which an “id” of a complex flow instance, an “id” of an instance of a complex task which is a shift destination, time (start) of the shift to the corresponding complex task, time (end) of the shift from the corresponding complex task to the next complex task, and an “id” of the complex task before the shift to the corresponding complex task (shift source complex task) are associated with each other. Each time the shift between the complex tasks is performed by the shift processing unit 152e, the history information 13g on the complex task after the shift is added.

Referring back to the descriptions of FIG. 2, the unexecuted task extraction unit 152fis a processing unit that extracts an unexecuted task when the shift between the complex tasks along the long-term flow is performed by the shift processing unit 152e.

For example, as illustrated in FIG. 15, when the shift is performed from the complex task Tk2h3 to the complex task Tk3h3, the unexecuted task extraction unit 152fextracts the unexecuted tasks Tk2h4 and Tk3h1. The unexecuted task extraction unit 152fgenerates unexecuted task information 13h including information on the extracted unexecuted tasks Tk2h4 and Tk3h1. FIG. 17 is a view illustrating an example of the unexecuted task information 13h. As illustrated in FIG. 17, the unexecuted task extraction unit 152fstores the unexpected task information 13h in which an “id” of a complex flow instance, a complex task which is a shift destination after the execution of an unexecuted task, and an “id” of the unexecuted task are associated with each other, in the storage unit 13. In addition, the shift destination after the execution of the unexecuted task is a complex task determined by the shift determination unit 152d when the unexecuted task is determined as a shift destination by the shift determination unit 152d, and is updated by the shift determination unit 152d. In addition, the unexecuted tasks Tk2h4 and Tk3h1 extracted by the unexecuted task extraction unit 152fare determined as shift candidates by the candidate extraction unit 152c.

Referring back to the descriptions of FIG. 2, the task execution unit 152g is a processing unit that executes the complex task which is the destination of the shift performed by the shift processing unit 152e.

For example, the task execution unit 152g refers to the complex task information 13d, and calls and executes a resource set for the complex task.

Further, the task execution unit 152g stores the execution result of the complex task in the storage unit 13. For example, when a resource is executed so that a file such as the customer information file is updated by the user terminal 30, the updated file is stored in the storage unit 13.

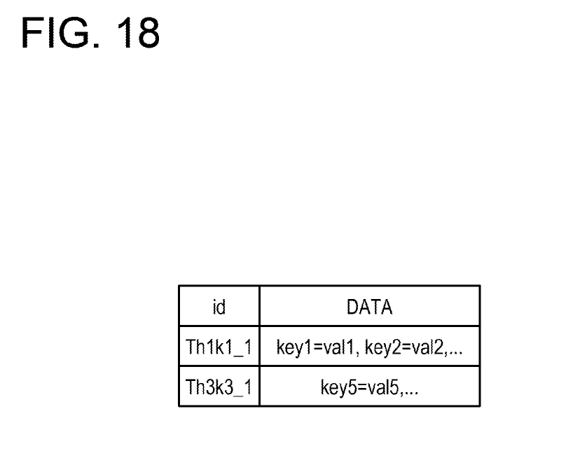

Alternatively, the task execution unit 152g stores, for example, an execution result of an application as the task instance information 13f in the storage unit 13. FIG. 18 is a view illustrating an example of the task instance information 13f. As illustrated in FIG. 18, the task instance information 13f is information in which an “id” of a complex task and data indicating an execution result of an application are associated with each other. For example, when the application is executed, values are set in variables according to an input from the user. In the example of FIG. 18, for example, the equation “key1=val1” indicating that the value “val1” is set in the variable “keyl” is stored in the storage unit 13 as data of the task instance information 13f that indicates the execution result of the application.

Subsequently, descriptions will be made on an example of a screen displayed on the user terminal 30 by the user display controller 152a at the time of executing the complex flow, with reference to FIGS. 19A and 19B. FIGS. 19A and 19B are views illustrating an example of a screen shift at the time of executing the complex flow. The screen shift of the user terminal 30 is controlled by the user display controller 152a. For example, it is assumed that the shift to the complex task Tk2h3 is performed by the shift processing unit 152e, and the current position of the complex flow is the complex task Tk2h3. In this case, the task execution unit 152g calls the resource set in the complex task Tk2h3. As illustrated in the left part of FIG. 19A, the user display controller 152a causes the user terminal 30 to display a screen P31 corresponding to the resource called by the task execution unit 152g. For example, in the left part of FIG. 19A, the user display controller 152a causes the user terminal 30 to display the screen P31 of a visiting application as the resource of the complex task Tk2h3 for performing a visiting for the information collection. On the screen P31 of the visiting application, a completion icon A31 of the visiting application is provided. When the user fills in the necessary items of the visiting application and operates the completion icon A31, the complex task Tk2h3 is ended.

When the complex task Tk2h3 is ended, the candidate extraction unit 152c extracts a shift candidate for a complex task which is a next shift destination. In this case, the user display controller 152a causes the user terminal 30 to display a screen P32 displaying the shift candidate as illustrated in the middle part of FIG. 19A. On the screen P32, for example, a selection icon A32 for selecting the complex task Tk2h4 (reporting of the information collection) which is the shift candidate along the short-term flow is provided. Further, a selection icon A33 for selecting the complex task Tk3h3 (visiting for proposal) which is the shift candidate along the long-term flow is provided.

When the user presses one of the selection icons A32 and A33, the shift determination unit 152d determines the complex task corresponding to the selection icon pressed by the user as the next shift destination. For example, in the middle part of FIG. 19A, it is assumed that the user selects the selection icon A33 corresponding to the complex task Tk3h3. In this case, the shift determination unit 152d determines the complex task Tk3h3 as the next shift destination, and the shift processing unit 152e performs the shift to the complex task Tk3h3. Further, the unexecuted task extraction unit 152fextracts the unexecuted tasks Th2h4 and Th3h1. The task execution unit 152g executes the complex task Tk3h3 which is the destination of the shift performed by the shift processing unit 152e. As a result, as illustrated in the right part of FIG. 19A, for example, the user display controller 152a causes the user terminal 30 to display a screen P33 of an application for visiting at the time of the contract proposal which is the resource set in the complex task Tk3h3.

In the middle part of FIG. 19A, when the selection icon A32 corresponding to the complex task Th2h4 which is the shift destination along the short-term flow is selected, the complex task Tk2h4 becomes the next shift destination, and the resource set in the complex task Tk2h4 is executed.

As illustrated in the right part of FIG. 19A, on the screen P33 of the application for the visiting at the time of the contract proposal, an application completion icon A34 is provided. When the user fills in the necessary items of the application and operates the completion icon A34, the complex task Tk3h3 is ended. In this way, in the shift between the complex tasks of the complex flow, the server device 10 may perform not only the shift along the short-term flow but also the shift along the long-term flow. Thus, for example, even when the user performs the contract proposal concurrently at the time of the visiting for the information collection, the tasks along the complex flow may be executed so that the user may more easily manage the tasks.

Next, when the completion icon A34 illustrated in the right part of FIG. 19A is operated so that the complex task Tk3h3 is ended, the candidate extraction unit 152c extracts a shift candidate for a complex task which is a next shift destination. In this case, the candidate extraction unit 152c extracts the complex tasks Tk3h4 and Tk4h3 as the shift destinations along the short-term flow and the long-term flow, and simultaneously, extracts the complex tasks Tk2h4 and Tk3h1 as the shift destinations of the unexecuted tasks. Thus, as illustrated in the left part of FIG. 19B, the user display controller 152a causes the user terminal 30 to display a screen P34 including selection icons A35 to A38 corresponding to the respective complex tasks Tk3h4, Tk4h3, Tk2h4, and Tk3h1. In addition, the complex task Tk3h4 is a task related to reporting at the time of the contract proposal. In addition, the complex task Tk4h3 is a task related to visiting at the time of the administrative procedure and is selected by the user, for example, in a case where the contract procedure is performed concurrently at the time of the contract proposal. The complex task Tk2h4 is a task related to reporting of the customer information collection, and corresponds to an unexecuted task that was skipped and was not executed at the previous shift. The complex task Tk3h1 is a task related to preparation for the contract proposal, and corresponds to an unexecuted task that was skipped and was not executed at the previous shift.

When the user presses any one of the selection icons A35 to A38, the shift determination unit 152d determines the complex task corresponding to the selection icon pressed by the user as the next shift destination. For example, in the left part of FIG. 19B, it is assumed that the user presses the selection icon A37. In this case, the shift determination unit 152d determines the complex task Tk2h4 which is the unexecuted task, as the next shift destination, and the shift processing unit 152e performs the shift to the complex task Tk2h4. In addition, the shift determination unit 152d determines the original complex task Tk3h3 as the shift destination after the execution of the complex task Tk2h4.

Subsequently, the task execution unit 152g executes the complex task Tk2h4 which is the destination of the shift performed by the shift processing unit 152e. Thus, as illustrated in the middle part of FIG. 19B, the user display controller 152a causes the user terminal 30 to display a screen P35 of an application for reporting at the time of the information collection which is the resource set in the complex task Tk2h4. As illustrated in the middle part of FIG. 19B, a completion icon A39 is provided on the screen P35 of the application for reporting at the time of the information collection. When the user fills in the necessary items of the application and operates the completion icon A39, the complex task Tk2h4 is ended.

When the complex task Tk2h4 is ended, the shift processing unit 152e performs the shift returning to the original complex task Tk3h3 according to the determination of the shift determination unit 152d. Since the process of the complex task Tk3h3 has already been ended, the candidate extraction unit 152c extracts the complex tasks Tk3h4 and Tk4h3 which are shift destinations along the short-term flow and the long-term flow, and the complex task Tk3h1 which is an unexecuted task, as the next shift candidates. Thus, as illustrated in the right part of FIG. 19B, the user display controller 152a causes the user terminal 30 to display a screen P36 including selection icons A35, A36, and A38 corresponding to the complex tasks Tk3h4, Tk4h3, and Tk3h1, respectively.

In this way, the server device 10 executes the unexecuted task of the complex flow which is the shift destination so that the unexecuted task may be more reliably executed even when the complex tasks are skipped. After executing the unexecuted task, the server device 10 performs the shift returning to the complex task which is the shift source of the unexecuted task. Thus, even when the unexecuted task is executed later, the server device 10 may more reliably execute each complex task along the complex flow.

[Complex Flow Generating Process]

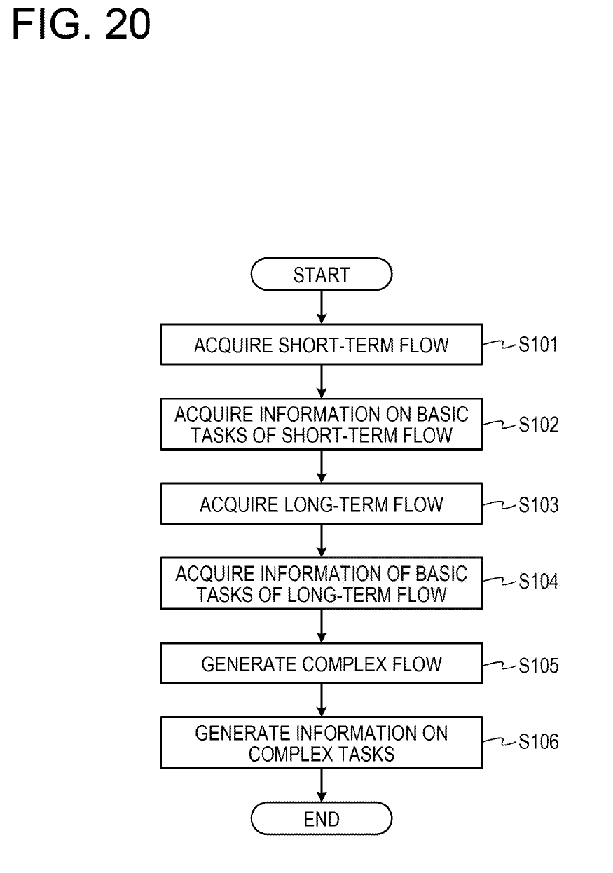

FIG. 20 is a flowchart illustrating a procedure of a complex flow generating process according to Embodiment 1. This process is merely an example and may be started according to a request from the administrator terminal 50.

As illustrated in FIG. 20, the basic flow acquisition unit 151b of the complex generation unit 151 acquires the short-term flow as a basic flow from the administrator terminal 50 (step S101). In addition, the basic task acquisition unit 151c acquires the information on the basic tasks included in the short-term flow (step S102).

Further, the basic flow acquisition unit 151b acquires the long-term flow as a basic flow from the administrator terminal 50 (step S103). The basic task acquisition unit 151c acquires the information on the basic tasks included in the long-term flow (step S104).

Then, the complex flow generation unit 151d generates the complex flow based on the short-term flow and the long-term flow acquired in steps S101 and S103 (step S105). In addition, based on the information on the basic tasks acquired in steps S102 and S104, the complex task generation unit 151e generates the information on the complex tasks (step S106), and the process is ended.

[Complex Flow Executing Process]

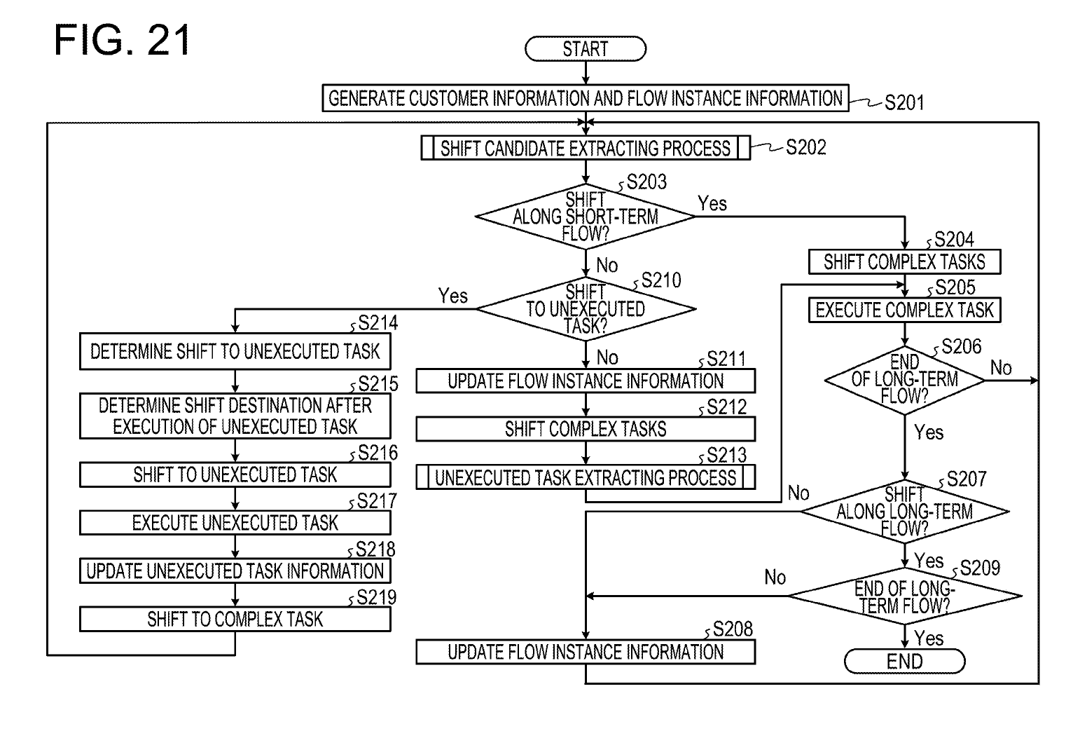

FIG. 21 is a flowchart illustrating a procedure of a complex flow executing process according to Embodiment 1. This process is merely an example and may be started when a new customer is registered by the user terminal 30.

As illustrated in FIG. 21, when a new customer is registered, the new registration unit 152b generates the customer information 13i and the flow instance information 13e (step S201). The candidate extraction unit 152c executes a process of extracting a shift candidate according to the current position and the shift attribute of the complex flow (step S202). For example, when the complex flow is started, the candidate extraction unit 152c extracts the complex task Tk1h1 at the head of the complex flow as the shift candidate. Meanwhile, when the shift between the complex tasks is performed once or more, the candidate extraction unit 152c extracts the shift candidate according to the complex task after the shift.

Then, based on the result of the selection of the shift candidate by the user terminal 30, the shift determination unit 152d determines whether the shift destination of the complex task is the shift along the short-term flow (step S203). When it is determined that the result of the selection by the user terminal 30 is the shift along the short-term flow (“Yes” in step S203), the shift processing unit 152e performs the shift between the complex tasks along the short-term flow (step S204), and the task execution unit 152g executes the complex task after the shift (step S205).

Subsequently, the candidate extraction unit 152c determines whether the current position of the complex task is the end of the short-term flow (step S206). When it is determined that the current position of the complex task is not the end of the short-term flow (“No” in step S206), the process returns to step S202. Meanwhile, when it is determined that the current position of the complex task is the end of the short-term flow (“Yes” in step S206), the candidate extraction unit 152c determines whether or not to perform the shift along the long-term flow (step S207).

When it is determined not to perform the shift along the long-term flow (“No” in step S207), the candidate extraction unit 152c updates the flow instance information 13e (step S208), and the process returns to step S202. Meanwhile, when it is determined to perform the shift along the long-term flow (“Yes” in step S207), the candidate extraction unit 152c determines whether the current position of the complex task is the end of the long-term flow (step S209).

When it is determined that the current position is the end of the long-term flow (“Yes” in step S209), the process is ended. This is because the current position of the complex task is the end of the complex flow.

Meanwhile, when it is determined that the current position is not the end of the long-term flow (“No” in step S209), the process proceeds to step S208.

Next, when the shift determination unit 152d determines in step S203 that the shift between the complex tasks is not the shift along the short-term flow (“No” in step S203), the shift determination unit 152d determines whether the shift between the complex tasks is the shift to an unexecuted task (step S210).

When it is determined that the shift between the complex tasks is not the shift to an unexecuted task (“No” in step S210), the shift determination unit 152d updates the flow instance information 13e (step S211), and the shift processing unit 152e performs the shift between the complex tasks along the long-term flow (step S212). Then, the unexecuted task extraction unit 152fexecutes the process of extracting an unexecuted task (step S213), and the process proceeds to step S205.

Meanwhile, when it is determined that the shift between the complex tasks is the shift to an unexecuted task (“Yes” in step S210), the shift determination unit 152d determines a shift to the unexecuted task selected by the user terminal 30 (step S214). In addition, the shift determination unit 152d determines the complex task before the shift to the unexecuted task, as a complex task which is a shift destination after the execution of the unexecuted task (step S215). The shift processing unit 152e executes the shift to the unexecuted task (step S216), and the task execution unit 152g executes the unexecuted task (step S217).

Then, the unexecuted task extraction unit 152fupdates the unexecuted task information 13h and deletes the executed unexecuted task (step S218). Then, the shift processing unit 152e executes the shift to the complex task determined by the shift determination unit 152d in step S215 (step S219), and the process returns to step S202.

[Shift Candidate Extracting Process]

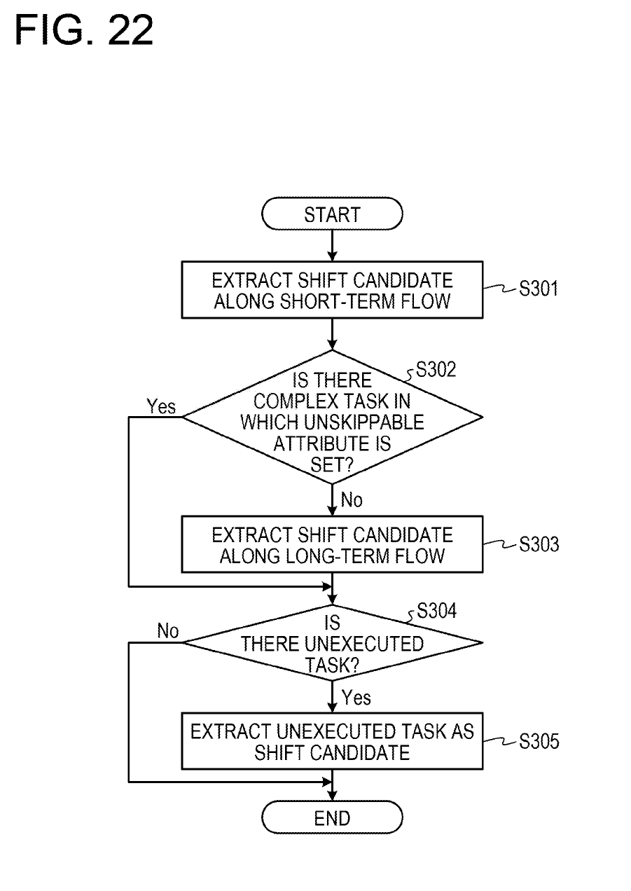

FIG. 22 is a flowchart illustrating a procedure of a shift candidate extracting process according to Embodiment 1. This process is merely an example and may be started by step S202 of the complex flow executing process illustrated in FIG. 21.

As illustrated in FIG. 22, the candidate extraction unit 152c extracts a complex task which is a shift destination in a case where the shift is performed along the short-term flow, as a shift candidate (step S301). Next, in a case where the shift is performed along the long-term flow, the candidate extraction unit 152c determines whether the complex task along the short-term flow includes a complex task in which the unskippable attribute is set (step S302). When it is determined that there is no complex task in which the unskippable attribute is set (“No” in step S302), the candidate extraction unit 152c extracts a shift destination in a case where the shift is performed along the long-term flow, as a shift candidate of the complex task (step S303). Meanwhile, when it is determined that there exists a complex task in which the unskippable attribute is set (“Yes” in step S302) or when the process of step S303 is ended, the candidate extraction unit 152c determines whether there is an unexecuted task (step S304). When it is determined that there is an unexecuted task (“Yes” in step S304), the candidate extraction unit 152c extracts the unexecuted task as a shift candidate (step S305), and the process is ended. Meanwhile, when it is determined that there is no unexecuted task (“No” in step S304), the process is ended.

[Unexecuted Task Extracting Process]

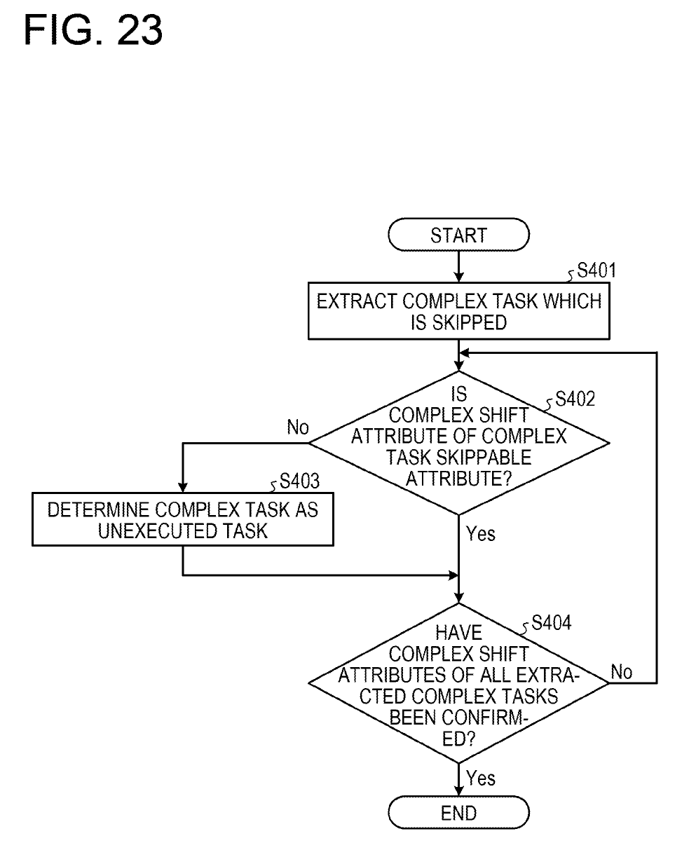

FIG. 23 is a flowchart illustrating a procedure of an unexecuted task extracting process according to Embodiment 1. This process is merely an example and may be started by step S213 of the complex flow executing process illustrated in FIG. 21.

As illustrated in FIG. 23, the unexecuted task extraction unit 152fextracts a complex task which is not executed and is skipped when the shift along the long-term flow is performed (step S401). Next, the unexecuted task extraction unit 152fdetermines whether the complex shift attribute of the extracted complex task is the skippable attribute (step S402). When it is determined that the complex shift attribute is not the skippable attribute (“No” in step S402), the unexecuted task extraction unit 152fdetermines the extracted complex task as an unexecuted task (step S403). Meanwhile, when it is determined that the complex shift attribute is the skippable attribute (“Yes” in step S402), the unexecuted task extraction unit 152fdetermines whether the complex shift attributes of all extracted complex tasks have been confirmed (step S404). When it is determined that there exists a complex task of which complex shift attribute has not been confirmed (“No” in step S404), the process returns to step S402. Meanwhile, when it is determined that the complex shift attributes of all extracted complex tasks have confirmed (“Yes” in step S404), the process is ended.

[One Aspect of Effects]

As described above, the server device 10 according to the present embodiment combines the plurality of basic flows with each other so as to generate the complex flow having the matrix structure. Further, the server device 10 executes the complex flow generated for each customer. At this time, the server device 10 performs the shift between the complex tasks along each of the plurality of basic flows according to the complex shift attributes of the complex tasks included in the complex flow. Thus, the plurality of basic flows may be comprehensively managed. As a result, according to the server device 10 of the present embodiment, it is possible to appropriately support the work of the insurance salesman.

### Embodiment 2

While the embodiment relating to the apparatus of the present disclosure has been described, the present disclosure may be implemented in various different forms, in addition to the embodiment described above. Thus, hereinafter, other embodiments included in the present disclosure will be described.

[Method of Inputting Basic Flow]

In Embodiment 1 described above, the administrator inputs the basic flows via the administrator terminal 50. However, the present disclosure is not limited thereto. For example, the administrator may select the basic flows stored in advance in the administrator terminal 50, such that the basic flow acquisition unit 151b may acquire the basic flows. In addition, the device storing the basic flows is not limited to the administrator terminal 50, and may be, for example, the server device 10 or another device connected to the network NW.

[Method of Generating Complex Tasks]

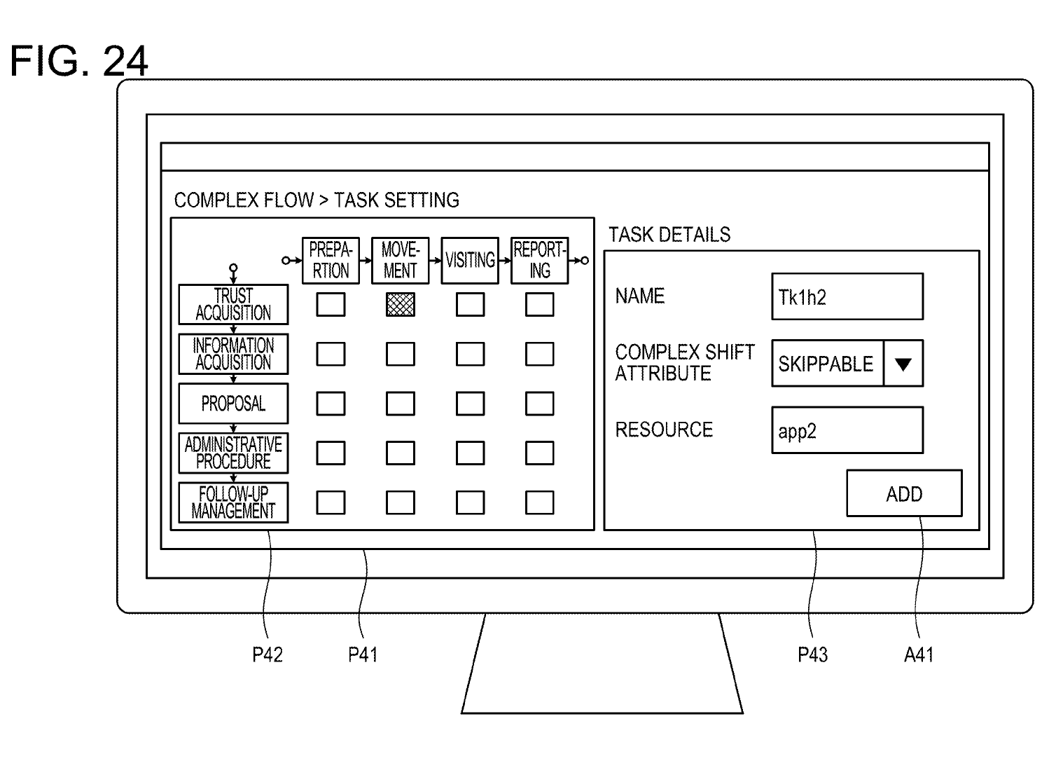

In Embodiment 1 described above, the complex task generation unit 151e generates the information on the complex tasks. However, the present disclosure is not limited thereto. For example, the administrator may input the information on the complex tasks via the administrator terminal 50. FIG. 24 is a view illustrating an example of a screen configuration at the time of generating the complex flow. When the complex task generation unit 151e acquires the information on the complex tasks from the administrator terminal 50, the administrator display controller 151a causes the administrator terminal 50 to display a screen P41 as illustrated in FIG. 24. The screen P41 includes a flow screen area P42 for displaying the complex flow, and a task screen area P43 for displaying details of a complex task included in the complex flow.

The flow screen area P42 displays the complex tasks included in the complex flow, the long-term flow, and the short-term flow. In addition, the task screen area P43 displays detailed information of the complex task Tk1h2 selected in the flow screen area P42. The detailed information of the complex task Tk1h2 includes, for example, the name of the complex task Tk1h2, the complex shift attribute, and the resource to be called at the time of executing the complex task Tk1h2. The complex shift attribute is selected from, for example, a pull-down menu. In addition, in the task screen area P43, a resource addition icon A41 for adding a resource to be called at the time of executing the complex task Tk1h2 is provided. For example, when the administrator operates the resource addition icon A41, a list of resources that may be added is displayed on the screen P41, and when the administrator selects a resource from the list, the selected resource is added to the complex task Tk1h2.

[Screen for Selecting Shift Candidate]

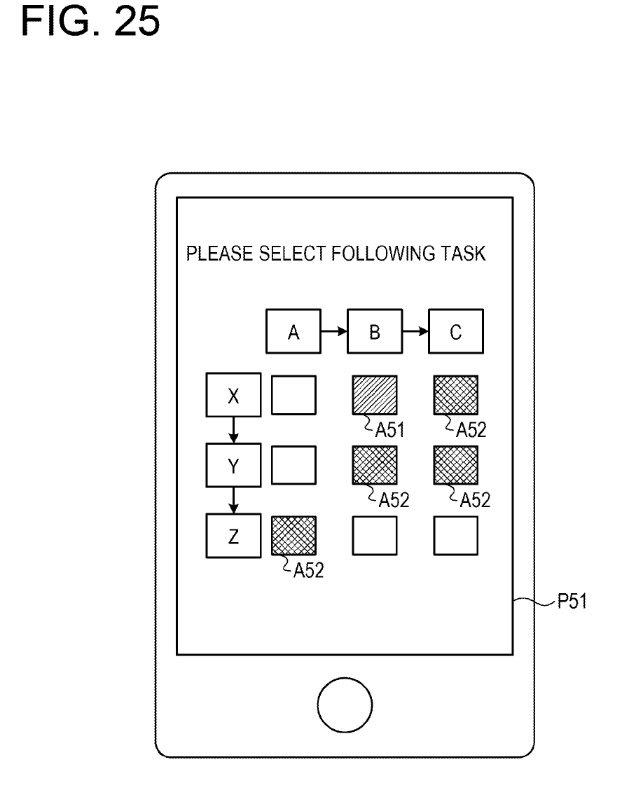

In Embodiment 1 described above, the candidate extraction unit 152c displays a list of selection candidates on the user terminal 30. However, the present disclosure is not limited thereto. For example, when the user selects a shift candidate, the user may select the shift candidate while checking the complex flow. FIG. 25 is a view illustrating an example of a screen configuration for presenting shift candidates. As illustrated in FIG. 25, the user display controller 152a causes the user terminal 30 to display an image P51 including the complex flow chart as an image representing the shift candidates. In FIG. 25, for the simplification of the illustration, the number of the basic tasks included in each of the short-term flow and the long-term flow is “3.” Further, in FIG. 25, the current position of the complex tasks is indicated by a selection icon A51 having a slanting line pattern, and the complex task of each shift candidate is indicated by a selection icon A52 having a mesh pattern.

As described above, the shift candidates are represented in the complex flow chart, so that the user may visually confirm the current position of the complex tasks or the positions of the shift candidates in the complex flow.

[Setting of Complex Shift Attribute]

In Embodiment 1 described above, when setting the complex shift attribute of the complex task, the complex task generation unit 151e sets the basic shift attribute of the short-term flow as the complex shift attribute. However, the present disclosure is not limited thereto. For example, the complex task generation unit 151e may set the shift attribute having the strict shift condition among the basic shift attributes of the short-term flow and the long-term flow as the complex shift attribute. In this case, the complex task generation unit 151e sets the complex shift attribute in an order of the “unskippable attribute,” the “post-executable attribute,” and the “skippable attribute.”

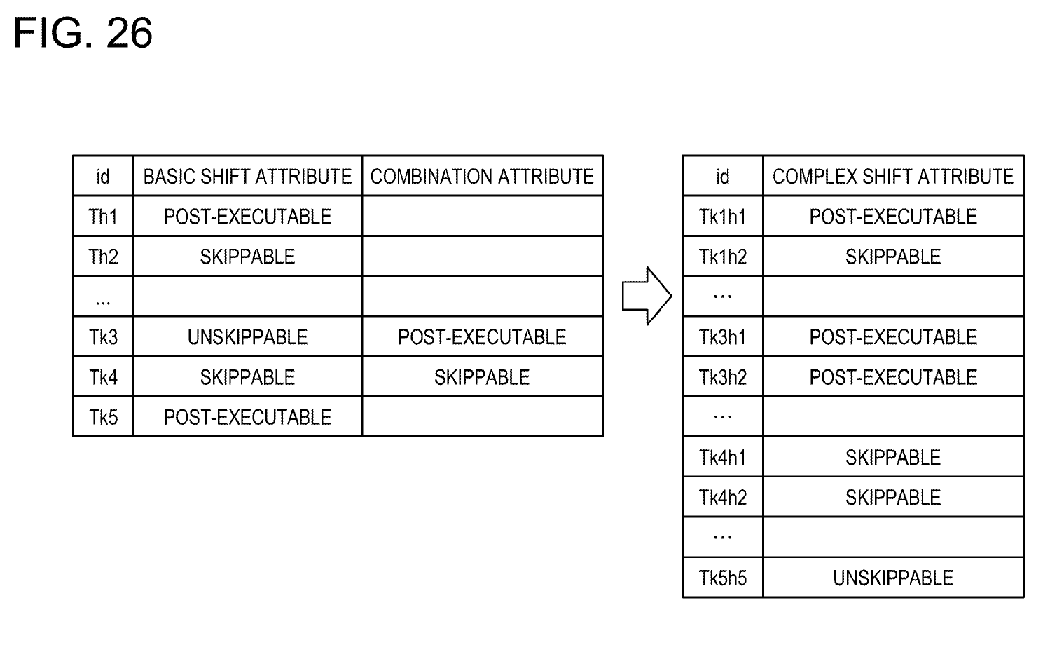

Alternatively, the administrator may set the complex shift attribute. FIG. 26 is a view for explaining an example of the setting of the complex shift attribute. As illustrated in the left part of FIG. 26, for example, the basic task acquisition unit 151c acquires not only a basic shift attribute of a basic task but also a combined shift attribute of the basic task and stores the attributes as the basic task information 13b in the storage unit 13. The combined shift attribute is an attribute that is set as a complex shift attribute of a complex task when the complex flow is generated by combining the short-term flow and the long-term flow with each other. In the left part of FIG. 26, the post-executable attribute and the skippable attribute are set as the combined shift attributes of the basic tasks Tk3 and Tk4 of the long-term flow, respectively. Thus, as illustrated in the right part of FIG. 26, the complex task generation unit 151e sets the post-executable attribute as the complex shift attributes of, for example, the complex tasks Tk3h1 and Tk3h2 corresponding to the basic task Tk3, without depending on the basic shift attributes of, for example, the basic tasks Th1 and Th2. Similarly, the complex task generation unit 151e sets the skippable attribute as the complex shift attributes of, for example, the complex tasks Tk4h1 and Tk4h2 corresponding to the basic task Tk4, without depending on the basic shift attributes of, for example, the basic tasks Th1 and Th2.

In addition, when combined shift attributes are set for both the short-term flow and the long-term flow, for example, the combined shift attribute set for the short-term flow may be set as the complex shift attribute.

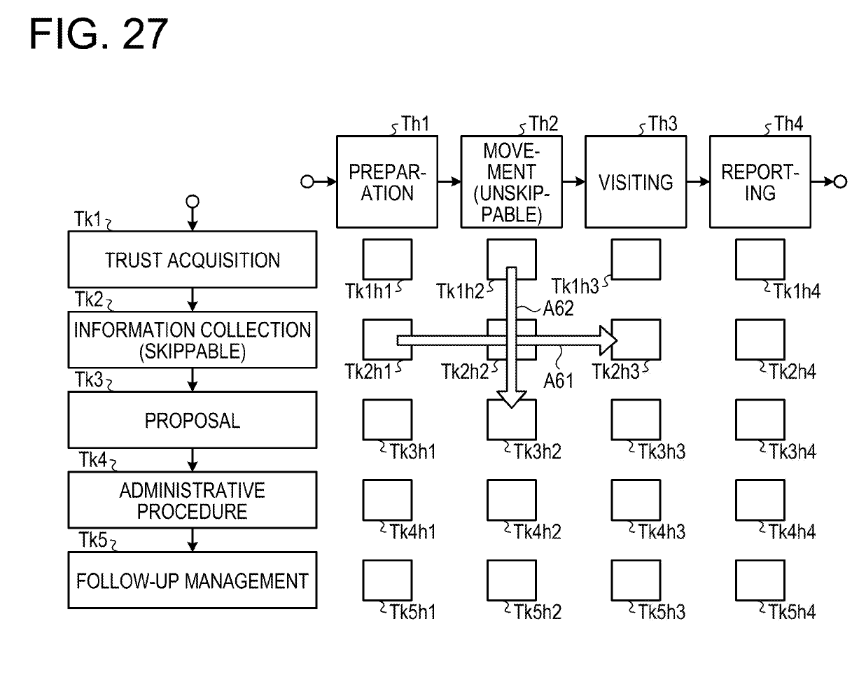

In addition, the complex task generation unit 151e may set the complex shift attribute according to the shift direction of the complex flow. That is, the complex task generation unit 151e sets the basic shift attribute of the short-term flow as the complex shift attribute in a case where the shift is performed along the short-term flow, and sets the basic shift attribute of the long-term flow as the complex shift attribute in a case where the shift is performed along the long-term flow. FIG. 27 is a diagram for explaining an example of the shift according to the complex shift attribute. As illustrated in FIG. 27, it is assumed that the basic shift attribute of the basic task Th2 corresponding to the complex task Tk2h2 is the unskippable attribute. At this time, assuming that the shift between the complex tasks is performed along the short-term flow as indicated by an arrow A61, the shift processing unit 152e executes the complex task Tk2h2 which is unskippable, and performs the shift to the next complex task Tk2h3. Meanwhile, it is assumed that the basic shift attribute of the basic task Tk2 corresponding to the complex task Tk2h2 is the skippable attribute. At this time, assuming that the shift between the complex tasks is performed along the long-term flow as indicated by an arrow A62, the shift processing unit 152e skips the complex task Tk2h2 and executes the shift to, for example, the complex task Tk3h2. In this way, the shift along the shift direction may be performed.

[Types of Complex Shift Attribute]

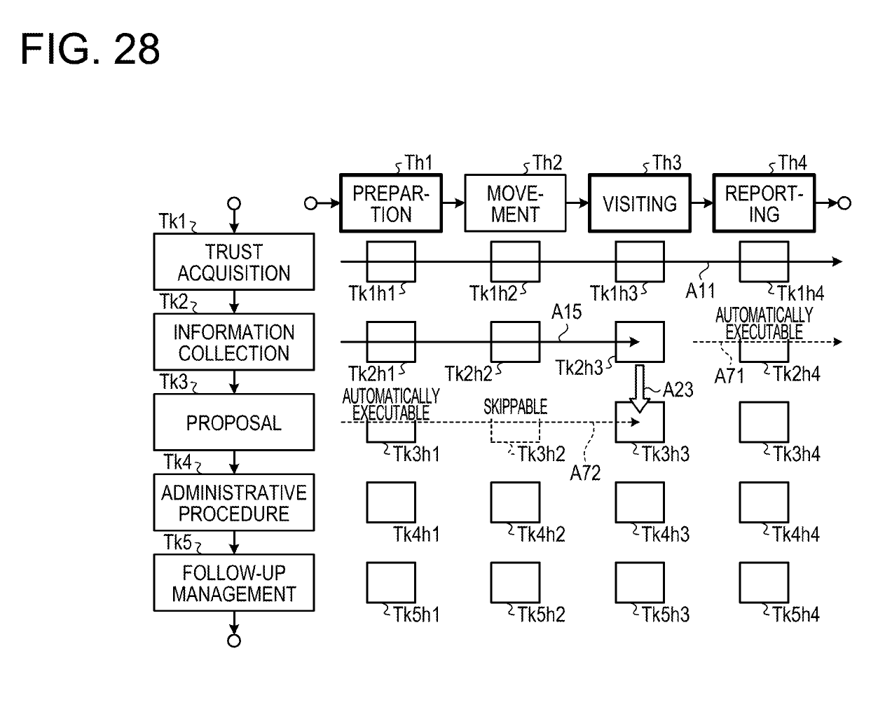

In Embodiment 1 described above, the complex shift attribute includes the three attributes including the skippable attribute, the unskippable attribute, and the post-executable attribute. The present disclosure is not limited thereto. In addition to the complex shift attributes above, for example, an automatically-executable attribute may be included in the complex shift attribute. The automatically-executable attribute is an attribute for permitting the task execution unit 152g to execute an unexecuted task, irrespective of an input from the user, when the unexecuted task is extracted. FIG. 28 is a diagram for explaining an example of the shift according to the complex shift attribute. As illustrated in FIG. 28, it is assumed that the shift is performed along arrows A11 and A15, and then, performed along an arrow A23. In this case, the unexecuted tasks Tk2h4 and Tk3h1 are extracted by the unexecuted task extraction unit 152f. When the automatically-executable attribute is set in the extracted unexecuted tasks Tk2h4 and Tk3h1, the shift processing unit 152e performs the shift to the unexecuted tasks Tk2h4 and Tk3h1 along arrows A71 and A72. Further, the task execution unit 152g executes the unexecuted tasks Tk2h4 and Tk3h1 after the shift. As a result, the complex flow may be executed even though the user does not execute the unexecuted tasks Tk2h4 and Tk3h1 so that the effort of the user may be reduced.

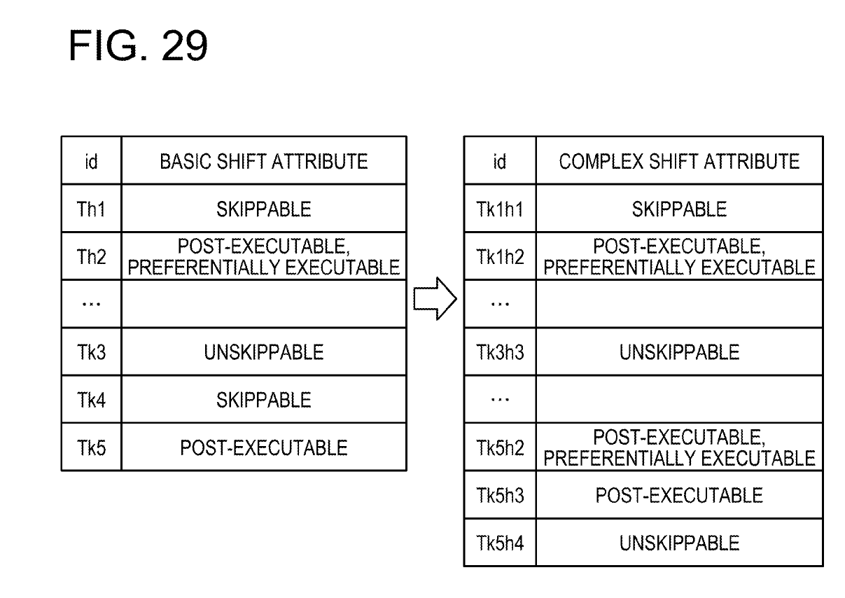

Alternatively, for example, a preferentially-executable attribute rather than the automatically-executable attribute described above may be included in the complex shift attribute. For example, when the unskippable attribute is set in a complex task, the shift for skipping the complex task along the long-term flow may not be performed. Thus, in order to skip the complex task in which the unskippable attribute is set and preferentially execute another complex task, it is assumed that the complex task generation unit 151e also sets the preferentially-executable attribute, in addition to the skippable attribute, the unskippable attribute, and the post-executable attribute. FIG. 29 is a view for explaining an example of the setting of the complex shift attribute. As illustrated in FIG. 29, when the preferentially-executable attribute is set in the basic task Th2, the complex task generation unit 151e sets the preferentially-executable attribute for the preferential execution in, for example, the complex tasks Tk1h2 and Tk5h2. As illustrated in FIG. 29, the preferentially-executable attribute is set together with another skippable attribute, unskippable attribute, or post-executable attribute. In this way, the complex task generation unit 151e may set a plurality of complex shift attributes.

When the preferentially-executable attribute is set in a complex task of a shift destination, the shift processing unit 152e performs the shift to the complex task in which the preferentially-executable attribute is set, even in a case where the unexecuted tasks include a complex task in which the unskippable attribute is set. In addition, it is assumed that after the execution of the complex task in which the preferentially-executable attribute is set, the shift processing unit 152e returns to the complex task before the shift to the complex task having the preferentially-executable attribute.

[Applications Other than Insurance Business]

In Embodiment 1 described above, the descriptions have been made on an example where the process of generating the complex flow or the process of executing the complex flow is applied to the information processing system 1 that manages the tasks performed by the insurance salesman. However, the application field is not limited to the insurance business. For example, the process of generating the complex flow or the process of executing the complex flow may also be applied to a bank field for supporting the sales of a bank's investment product, a hospital diagnosis field for supporting the diagnosis in a hospital, and an in-company work field for supporting a management of a project such as a program development in a company, from the viewpoint of the necessity for the management of the complex flow generated by combining a plurality of basic flows with each other.

At this time, when the information processing system 1 supports the work for the sales of the bank's investment product, as an example, a workflow for receiving a customer visiting the bank, guiding a seat, providing a service, and seeing the customer leaving the bank corresponds to the short-term flow. In addition, a workflow for explaining a stock investment or an investment product to a customer and buying or selling an investment product corresponds to the long-term flow.

In addition, when the information processing system 1 is applied to the hospital diagnosis field, as an example, a workflow from the diagnosis to the payment corresponds to the short-term flow. In addition, as diagnosis contents, a workflow for performing a simple examination, performing a diagnosis or a precise examination based on the examination result, and performing curing correspond to the long-term flow.

In addition, when the information processing system 1 is applied to the program development work, as an example, a workflow including designing, implementing, and examining a program corresponds to the short-term flow. In addition, a workflow for sequentially implementing a plurality of functions of the program corresponds to the long-term flow.

As described above, a plurality of work flows may be comprehensively managed even in the fields other than the management of the tasks performed by the insurance salesman.

[Complex Flow with Multidimensional Matrix Structure]

In Embodiment 1 described above, the complex flow having the two-dimensional matrix structure is described as an example. However, the structure of the complex flow is not limited to the two-dimensional matrix structure. For example, the complex flow generation unit 151d may generate a complex flow having a three-dimensional matrix structure in which a short-term flow, a medium-term flow, and a long-term flow are combined with each other. Alternatively, the complex flow generation unit 151d may generate a complex flow having a four- or higher multi-dimensional matrix structure by combining four or more basic flows with each other.

[Configuration of Basic Flow]

In Embodiment 1 described above, the descriptions have been made on a case where each basic flow includes no conditional branch, and the basic tasks are sequentially executed. However, the present disclosure is not limited thereto. For example, the basic flow may include a conditional branch or an iteration.

[Distribution and Integration]

In addition, each component of the respective illustrated devices is not necessarily required to be configured physically as illustrated. That is, specific forms of distribution or integration of the respective devices are not limited to those illustrated. That is, all or some of the devices may be configured to be functionally or physically distributed or integrated in arbitrary units depending on, for example, various loads or use conditions. For example, the administrator display controller 151a, the basic flow acquisition unit 151b, the basic task acquisition unit 151c, the complex flow generation unit 151d, the complex task generation unit 151e, the user display controller 152a, the new registration unit 152b, the candidate extraction unit 152c, the shift determination unit 152d, the shift processing unit 152e, the unexecuted task extraction unit 152f, and the task execution unit 152g may be connected to each other via a network NW which is an external device of the server device 10. Alternatively, the administrator display controller 151a, the basic flow acquisition unit 151b, the basic task acquisition unit 151c, the complex flow generation unit 151d, the complex task generation unit 151e, the user display controller 152a, the new registration unit 152b, the candidate extraction unit 152c, the shift determination unit 152d, the shift processing unit 152e, the unexecuted task extraction unit 152f, and the task execution unit 152g may be included in separate devices, respectively, and connected to a network to cooperate with each other so that the function of the server device 10 described above is implemented.

[Complex Flow Program]

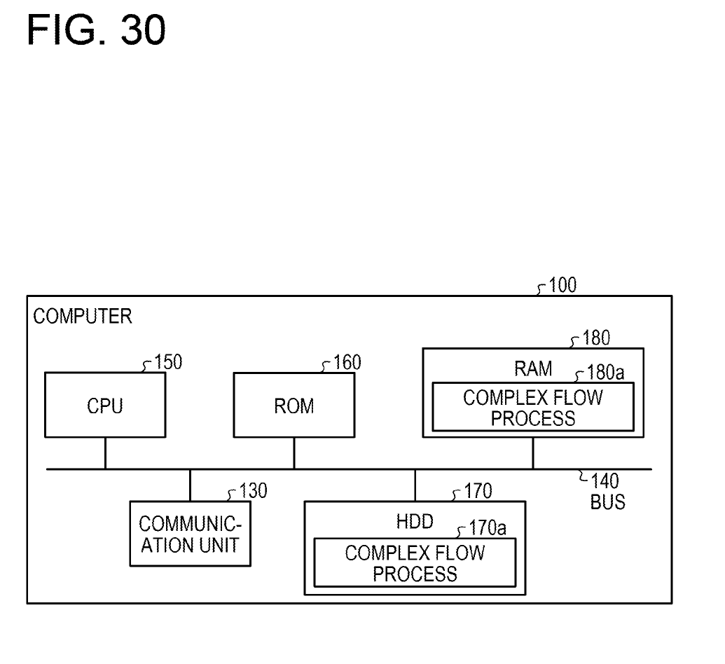

In addition, the various processes in the embodiments described above may be implemented by causing a prepared program to be executed by a computer such as a personal computer or a workstation. Thus, hereinafter, descriptions will be made on an example of a computer that executes a complex flow program having the same functions as those in the embodiments described above, with reference to FIG. 30.

FIG. 30 is a diagram illustrating an example of a hardware configuration of a computer that executes a complex flow program related to Embodiments 1 and 2. As illustrated in FIG. 30, a computer 100 includes a communication unit 130, a CPU 150, a ROM 160, an HDD 170, and a RAM 180. The components 130 to 180 are connected to each other via a bus 140.

As illustrated in FIG. 30, the HDD 170 stores a complex flow program 170a exhibiting the same functions as those of the administrator display controller 151a, the basic flow acquisition unit 151b, the basic task acquisition unit 151c, the complex flow generation unit 151d, the complex task generation unit 151e, the user display controller 152a, the new registration unit 152b, the candidate extraction unit 152c, the shift determination unit 152d, the shift processing unit 152e, the unexecuted task extraction unit 152f, and the task execution unit 152g which are described above in Embodiment 1. The complex flow program 170a may be integrated or distributed, like the administrator display controller 151a, the basic flow acquisition unit 151b, the basic task acquisition unit 151c, the complex flow generation unit 151d, the complex task generation unit 151e, the user display controller 152a, the new registration unit 152b, the candidate extraction unit 152c, the shift determination unit 152d, the shift processing unit 152e, the unexecuted task extraction unit 152f, and the task execution unit 152g which are illustrated in FIG. 2. That is, the HDD 170 may not necessarily store all the data described in Embodiment 1 above, and may store merely the data used for the processes.

Under the circumstances, the CPU 150 reads the complex flow program 170a from the HDD 170, and then, develops the program in the RAM 180. As a result, the complex flow program 170a functions as a complex flow process 180 as illustrated in FIG. 30. The complex flow process 180a develops the various data read from the HDD 170 in a portion of the storage area of the RAM 180 which is allocated to the complex flow process 180a, and executes the various processes by using the developed various data. The processes executed by the complex flow process 180a include, for example, the processes illustrated in FIGS. 20 to 23. In addition, in the CPU 150, all the processing units described in Embodiment 1 above may not be necessarily operated, and merely the processing unit corresponding to the process to be executed may be virtually implemented.

In addition, the complex flow program 170a described above may not be necessarily stored in the HDD 170 or the ROM 160 from the beginning. For example, the complex flow program 170a may be stored in a “portable physical medium” such as a flexible disk, so-called FD, CD-ROM, DVD disk, magneto-optical disk, or IC card which is inserted into the computer 100. The computer 100 may acquire the complex flow program 170a from the portable physical medium and execute the program. In addition, the complex flow program 170a may be stored in, for example, another computer or server device which is connected to the computer 100 via a public line, the Internet, the LAN, or the WAN, such that the computer 100 acquires the complex flow program 170a from the another computer or server device and executes the program.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. An information processing apparatus, comprising:
a memory; and
a processor coupled to the memory and the processor configured to:
acquire a plurality of basic flows each including a plurality of basic tasks;
generate a complex flow having a multi-dimensional matrix structure by combining the plurality of basic flows with each other, the complex flow including a plurality of complex tasks corresponding to any of the basic tasks of the respective basic flows;
set complex shift attributes for the respective complex tasks based on a basic shift attribute set for each of the plurality of basic tasks of at least one of the plurality of basic flows, each of the complex shift attributes including information on a shift between the plurality of complex tasks, the basic shift attribute including information on a shift between the plurality of basic tasks; and
perform a shift between the plurality of complex tasks starting from a head complex task of the plurality of complex tasks based on the complex shift attributes, the head complex task corresponding to head basic tasks of the respective basic flows.

2. The information processing apparatus according to claim 1, wherein the processor configured to:
perform a shift between the plurality of complex tasks along a first basic flow of the plurality of basic flows.

3. The information processing apparatus according to claim 2, wherein the processor configured to:
perform a shift to a first complex task of the plurality of complex tasks upon completing the shift along the first basic flow, the first complex task corresponding to the head task of the first basic flow.

4. The information processing apparatus according to claim 2, wherein the processor configured to:
perform a sequential shift, upon completing the shift along the first basic flow, to a first complex task of the plurality of complex tasks along a second basic flow of the plurality of basic flows, the first complex task corresponding to the head task of the first basic flow, the second basic flow being different from the first basic flow.

5. The information processing apparatus according to claim 4, wherein the processor configured to:
perform a skip shift from a second complex task of the plurality of complex tasks to a third complex task of the plurality of complex tasks along the second basic flow, the second complex task and the third complex task corresponding to a first basic task of the first basic flow.

6. The information processing apparatus according to claim 5, wherein
one of the complex shift attributes set for a specific complex task is an unskippable attribute for permitting a shift from the specific complex task to another complex task on a condition that the specific complex task be executed, and
the processor configured to:
perform the skip shift depending on whether the unskippable attribute is set for any of the complex tasks included in the sequential shift from the second complex task to the third complex task.

7. The information processing apparatus according to claim 5, wherein the processor configured to:
extract, upon performing the skip shift from the second complex task to the third complex task, a fourth complex task of the plurality of complex tasks from among the complex tasks included in the sequential shift from the second complex task to the third complex, the fourth complex task being unexecuted in accordance with a complex shift attribute set for the fourth complex task.

8. The information processing apparatus according to claim 7, wherein the processor configured to:
perform a shift to the fourth complex task; and
perform, after the extracted complex task is executed, a shift returning to the third complex task.

9. The information processing apparatus according to claim 5, wherein the processor configured to:
execute, when the skip shift from the second complex task to the third complex task is performed, the complex tasks included in the sequential shift from the second complex task to the third complex.

10. The information processing apparatus according to claim 2, wherein the processor configured to:
set the basic shift attributes set for the respective basic tasks of the first basic flow, as the complex shift attributes for the complex tasks corresponding to the respective basic tasks of the first basic flow.

11. The information processing apparatus according to claim 1, wherein the processor configured to:
set, as the complex shift attributes for the complex tasks, the basic shift attributes set for the basic tasks of the respective basic flows in association with shift directions of the respective basic flows; and
perform the shift between the complex tasks based on a complex shift attribute corresponding to a shift direction of the shift between the complex tasks.

12. The information processing apparatus according to claim 1, wherein the processor configured to:
extract candidates for a destination of the shift based on the plurality of basic flows and the complex shift attributes; and
perform a shift to one of the candidates.

13. The information processing apparatus according to claim 1, wherein
one of the complex shift attributes set for a specific complex task is a preferentially executable attribute for permitting shift to the specific complex task independently of the complex shift attributes set for the plurality of complex tasks and the current position in the shift, and
the processor configured to:
perform, when the preferentially executable attribute is set for the specific complex task, a shift to the specific complex task; and
perform, after the specific complex task is executed, a shift returning to the current position.

14. The information processing apparatus according to claim 1, wherein the processor configured to:
output information on the complex tasks to a terminal; and
execute the complex tasks in accordance with an input from the terminal.

15. An information processing method, comprising:
acquiring, by a computer, a plurality of basic flows each including a plurality of basic tasks;
generating a complex flow having a multi-dimensional matrix structure by combining the plurality of basic flows with each other, the complex flow including a plurality of complex tasks corresponding to any of the basic tasks of the respective basic flows;
setting complex shift attributes for the respective complex tasks based on a basic shift attribute set for each of the plurality of basic tasks of at least one of the plurality of basic flows, each of the complex shift attributes including information on a shift between the plurality of complex tasks, the basic shift attribute including information on a shift between the plurality of basic tasks; and
performing a shift between the plurality of complex tasks starting from a head complex task of the plurality of complex tasks based on the complex shift attributes, the head complex task corresponding to head basic tasks of the respective basic flows.

16. The information processing method according to claim 15, further comprising:
performing a shift between the plurality of complex tasks along a first basic flow of the plurality of basic flows.

17. The information processing method according to claim 16, further comprising:
performing a shift to a first complex task of the plurality of complex tasks upon completing the shift along the first basic flow, the first complex task corresponding to the head task of the first basic flow.

18. A non-transitory computer-readable recording medium having stored therein a program that causes a computer to execute a process, the process comprising:
acquiring a plurality of basic flows each including a plurality of basic tasks;
generating a complex flow having a multi-dimensional matrix structure by combining the plurality of basic flows with each other, the complex flow including a plurality of complex tasks corresponding to any of the basic tasks of the respective basic flows;
setting complex shift attributes for the respective complex tasks based on a basic shift attribute set for each of the plurality of basic tasks of at least one of the plurality of basic flows, each of the complex shift attributes including information on a shift between the plurality of complex tasks, the basic shift attribute including information on a shift between the plurality of basic tasks; and
performing a shift between the plurality of complex tasks starting from a head complex task of the plurality of complex tasks based on the complex shift attributes, the head complex task corresponding to head basic tasks of the respective basic flows.

19. The non-transitory computer-readable recording medium according to claim 18, the process further comprising:
performing a shift between the plurality of complex tasks along a first basic flow of the plurality of basic flows.

20. The non-transitory computer-readable recording medium according to claim 19, the process further comprising:
performing a shift to a first complex task of the plurality of complex tasks upon completing the shift along the first basic flow, the first complex task corresponding to the head task of the first basic flow.
